(19) United States
(12) Patent Application Publication
(10) Pub. No.: US 2020/0262765 A1
(43) Pub. Date: Aug. 20, 2020

(54) PRODUCTION OF NUTRIGEL MATERIALS FROM SOYA WASTE

(71) Applicant: National University of Singapore, Singapore (SG)

(72) Inventors: Jun LI, Singapore (SG); Jingling ZHU, Singapore (SG); Xia SONG, Singapore (SG); Choon Nam ONG, Singapore (SG); Chiang Shiong LOH, Singapore (SG); Wee Kee TAN, Singapore (SG)

(21) Appl. No.: 16/643,177

(22) PCT Filed: Aug. 27, 2018
(86) PCT No.: PCT/SG2018/050431

§ 371 Date: Feb. 28, 2020

(30) Foreign Application Priority Data
Aug. 28, 2017 (SG) 10201707018V

(51) Int. Cl. C05G 3/80; C05G 3/70; C05G 5/18; C05C 9/00; C09K 17/32

(52) U.S. Cl. CPC C05G 3/80; C05G 3/70; C09K 17/32; C05C 9/00; C05G 5/18

(57) ABSTRACT

Disclosed herein are superabsorbent hydrogels formed using okara particles and polymeric chains. The hydrogel contains crosslinks, which are provided by crosslinking groups between the polymeric chains or by a plurality of polymer chains being bonded to each okara particle (with each of these chains being bonded to at least one further okara particle too). The resulting superabsorbent hydrogels are useful in aiding plant growth, nutrition and hydration, and may be mixed with soil to form a composite material for such purposes.

### CROSS-REFERENCE TO RELATED APPLICATIONS

The present application is a filing under 35 U.S.C. 371 as the National Stage of International Application No. PCT/SG2018/050431, filed Aug. 27, 2018, entitled “PRODUCTION OF NUTRIGEL MATERIALS FROM SOYA WASTE,” which claims priority to Singapore Application No. SG 10201707018V filed with the Intellectual Property Office of Singapore on Aug. 28, 2017 and entitled “PRODUCTION OF “NUTRIGEL” MATERIALS FROM SOYA WASTE,” both of which are incorporated herein by reference in their entirety for all purposes.

### FIELD OF INVENTION

This invention relates to hydrogels that are derived from soya residue (Okara) and methods of making the same. The hydrogels may be used as soil additives in agriculture.

### BACKGROUND

The listing or discussion of a prior-published document in this specification should not necessarily be taken as an acknowledgement that the document is part of the state of the art or is common general knowledge.

In soil-based farming, water and nutrients are essential for plant growth. Conventional soil-based farming suffers from low efficiency with regard to the utilisation of water and nutrients. This leads to over-fertilization and leaching, resulting in groundwater contamination.

The efficiency of water and nutrient use could be improved through the development of controlled release water-absorbent materials coated with fertilizers as eco-friendly soil additives. Superabsorbent polymer materials have been widely used in this area due to their ability to imbibe water that is hundreds of times higher than their own weight and which cannot be easily removed even under extended pressure.

Common superabsorbent polymer materials are generally hygroscopic materials. In an attempt to reduce the cost of materials, there is an emerging trend to utilize wastes, such as sewage sludge and horticultural waste, flax yarn waste, and waste mulberry branches.

### SUMMARY OF INVENTION

In Singapore, large quantities of soybean residue (okara) are produced on a daily basis, which is mostly disposed of or burned as waste. As a by-product of soybean milk and tofu production, okara contains around 40-60% fiber on a dry matter basis and has the potential to be developed into a superabsorbent material. Its fiber component was reported to be hemicellulose, cellulose, lignin, and phytic acid, which contains large amounts of hydroxyl and carboxyl groups that make it possible to convert okara into superabsorbent materials. In addition, other components of okara, including proteins, oils, carbohydrates, vitamins and minerals may be used as nutrients in soil that will be beneficial for plant growth. This invention provides some examples for modifying okara and converting it into a soil supplement described herein as “Nutrigel”, which can enhance soil properties for more efficient plant or crop production (vegetables, fruits, trees, etc.).

Thus, in a first aspect of the invention, there is provided a superabsorbent hydrogel comprising a crosslinked polymeric network comprising polymeric chains grafted onto particles of okara, wherein the crosslinks are formed through:
the polymeric chains; and/or
each okara particle being bonded to one or more polymeric chains.

In general embodiments of the invention:

(a) the okara particles may be one or more of unfractionated okara particles, water-insoluble okara particles, and water-soluble okara particles;

(b) the hydrogel may further comprise a plant nutrient material (e.g. the plant nutrient material may be urea).

In certain embodiments of the invention, the polymeric chains may be formed from poly(acrylic acid), poly(acrylamide) or copolymers thereof. In embodiments where polymeric chains are formed from poly(acrylic acid), poly(acrylamide) or copolymers thereof:

(a) the crosslinks formed through the polymeric chains may be derived from a bisacrylamide crosslinking agent, optionally wherein the bisacrylamide crosslinking agent is N, N′-methylenebisacrylamide;

(b) the crosslinking agent may be present in the hydrogel in an amount of from 0.010 to 2 dry wt % of the hydrogel, such as from 0.1 to 1 dry wt %, such as from 0.16 to 0.34 dry wt %;

(c) the okara particles may form from 15 to 50 dry wt % and the polymeric chain may form from 50 to 85 dry wt % of the hydrogel, such as from 20 to 50 dry wt % of okara particles and from 50 to 80 dry wt % of polymeric chain, such as from 25 to 40 dry wt % of okara

particles and from 60 to 75 dry wt % of polymeric chain, such as from 30 to 34 dry wt % of okara particles and from 66 to 70 dry wt % of polymeric chain;

(d) the polymeric chains may be a copolymer of acrylic acid and acrylamide (e.g. the weight to weight ratio of acrylic acid to acrylamide in the polymeric chains is from 1:10 to 10:1, such as from 3:7 to 7:3, such as 7:3);

(e) the hydrogel may have an equilibrium swelling value of from 90 to 500 at a pH value of around 7.

In further embodiments of the invention, the hydrogel may be formed by the reaction of carboxylated okara particles that comprise one or more carboxylic acid functional groups with polymeric chains that comprise two or more epoxide groups, where an ester linkage is formed by reaction of a carboxylate group with an epoxide. In such embodiments:

(a) the polymeric chains that comprise two or more epoxide linkages may be polyethylene glycol diglycidyl ether;

(b) the weight to weight ratio of carboxylated okara to polymeric chains that comprise two or more epoxide groups may be from 1:2 to 2:1, such as from 1:1.2 to 1:0.6;

(c) the hydrogel may have an equilibrium swelling value of from 10 to 110.

In a second aspect of the invention, there is provided a use of a superabsorbent hydrogel as in agriculture, where the superabsorbent hydrogel is as defined in the first aspect of the invention or in any technologically sensible combination of its embodiments. In embodiments of the second aspect of the invention, the hydrogel may further comprise a plant nutrient material, optionally wherein the plant nutrient material is urea.

In a third aspect of the invention, there is provided a composite material for use in growing plants, comprising a soil and a superabsorbent hydrogel as defined in the first aspect of the invention or in any technologically sensible combination of its embodiments.

In embodiments of the third aspect of the invention:

(a) the composite material may comprise from 0.5 to 10 dry wt % of the hydrogel (e.g. from 1 to 5 dry wt % of the hydrogel, such as from 2 to 3 dry wt %;

(b) the composite material may have a water holding percentage of from 125 to 250%, such as from 145 to 230%, such as from 175 to 225%;

(c) the hydrogel may further comprise a plant nutrient, optionally wherein the plant nutrient is urea (e.g. the plant nutrient may be released from the composite material over a period of from 3 to 20 days, such as from 4 to 18 days, such as from 10 to 15 days, such as 14 days).

In a fourth aspect of the invention, there is provided a method of forming a superabsorbent hydrogel as defined in the first aspect of the invention where the polymeric chains may be formed from poly(acrylic acid), poly(acrylamide) or copolymers thereof (and any technically sensible combination of the appropriate embodiments), the method comprising the steps of:
(a) providing an aqueous suspension of okara;
(b) adding a radical initiator to the aqueous suspension to form a first reaction mixture that was aged for a first period of time;
(c) adding acrylic acid and/or acrylamide with a crosslinking agent to the first reaction mixture to form a second reaction mixture that was aged for a second period of time to form the superabsorbent hydrogel.

In a fifth aspect of the invention, there is provided a method of forming a superabsorbent hydrogel as defined in the first aspect of the invention where the hydrogel may be formed by the reaction of carboxylated okara particles that comprise one or more carboxylic acid functional groups with polymeric chains that comprise two or more epoxide groups, where an ester linkage is formed by reaction of a carboxylate group with an epoxide (and any technically sensible combination of the appropriate embodiments), the method comprising the steps of:
(a) providing an aqueous suspension of carboxylated okara in an alkaline aqueous solution; and
(b) adding a polymeric chain material that has two or more epoxide groups to the aqueous suspension to react with the carboxylated okara to form the superabsorbent hydrogel.

### DRAWINGS

FIG. 1. FT-IR spectra of Ok(01) and its insoluble component (Ok(01)-I) and soluble component (Ok(01)-S).

FIG. 2. Synthetic route of Ok(01)-I-PAA via graft polymerization.

FIG. 3. ¹H NMR spectra of Ok(01), Ok(01)-I, Ok(01)-I-PAA 1:2 precipitates and Ok(01)-I-FAA 1:2 supernatant in CDC1₃.

FIGS. 4A to 4C. Microscopic images of (a) Ok(01)-I-PAA 1:2 supernatant, (b) PAA (control of 1:2) supernatant and (c) Ok(01)-I supernatant. Scale bar=200 μm.

FIG. 5. FT-IR spectra of Ok(01), Ok(01)-I, Ok(01)-I-PAA 1:2 precipitates, Ok(01)-I-PAA 1:2 supernatant and PAA (control of 1:2) in the form of KBr discs.

FIGS. 6A and 6B. FIG. 6A - Oscillatory time sweeps of Ok(01)-I-PAA 1:2 and PAA (control of 1:2) were performed at a constant shear stress of 1.0 Pa and a fix frequency of 1.0 Hz at 25° C. Storage modulus (G′) and loss modulus (G″) were plotted versus time. FIG. 6B—The shear viscosity was measured by applying increasing shear rate logarithmically from 0.1 Pa to 100 Pa at 25° C.

FIGS. 7A to 7C. Photos of nutrigel and wetting agent in tea bags at dry state (FIG. 7A) and wet state (FIGS. 7B and 7C) (FIG. 7B: front view, FIG. 7C: side view).

FIGS. 8A and 8B. FIG. 8A—Pictures of small and big powder particles of Ok(01)-P(AANa₇-co-AAm₃) Gel1-2_MBA_{0.05}. FIG. 8B—Water absorbency of Ok(01)-P(AANa₇-co-AAm₃) gels.

FIG. 9. Water holding measurements of soil containing gel particles (1 and 3 wt % of soil). Commercial soil (use as received) was used as control.

FIGS. 10A and 10B. Water retention measurements of soil containing gel particles, FIG. 10A—1 wt % of soil and FIG. 10B—3 wt % of soil. Commercial soil (use as received) was used as control.

FIG. 11. Water holding measurements of soil containing gel particles (1 and 3 wt % of soil) after 7 cycles of wetting and drying.

FIG. 12. Cumulative release curve of urea from soil or NUSoil.

FIG. 13. FT-IR spectra of Ok(01)-I and CM-Ok(01)-I-a synthesized using 15 wt % and 25 wt % NaOH.

FIG. 14. Photograph of 10 wt % of Ok(01)-I and CM-Ok(01)-I-a in water. CM-Ok(01)-I-a was synthesized using 25 wt % NaOH.

FIG. 15. FT-IR spectra of Ok(01), CM-Ok(01)-a and CM-Ok(01)-b samples synthesized using 15 wt % NaOH as listed in Table 6.

FIGS. 16A and 16B. FIG. 16A—Schematic illustration and FIG. 16B—typical workflow for CM-Ok(01)-PEG hydrogel synthesis via crosslinking of CM-Ok(01) with PEGDE.

FIGS. 17A to 17E. Photographs of the resultant reaction mixtures of Ok(01) or CM-Ok(01)-a with various amounts of PEGDE crosslinker for the reactions listed in Table 7. FIG. 17A—Ok(01)-PEG (1:1.2) suspension; FIG. 17B—CM-Ok(01)-a-PEG (1:1.2) gel; FIG. 17C—CM-Ok(01)-a-PEG (1:0.8) gel; FIG. 17D—CM-Ok(01)-a-PEG (1:0.6) gel; FIG. 17E—CM-Ok(01)-a-PEG (1:0.4) suspension.

FIG. 18. Swelling ratios of CMC-PEG and CM-Ok(01)-a-PEG hydrogels in water with time. The inset table shows the equilibrium swelling ratios (Q_{eq}) of these hydrogels in water.

FIGS. 19A and 19B. FIG. 19A—Oscillatory stress sweep measurement of CM-Ok(01)-b2-PEG hydrogels at a constant frequency of 1.0 Hz at 25° C. FIG. 19B—Oscillatory frequency sweep measurement of CM-Ok(01)-b2-PEG hydrogels at a constant shear stress of 1.0 Pa at 25° C.

FIGS. 20A to 20C. Preliminary screening of nutrigels for downstream application studies. Nutrigels (Gel1, Gel2 and Gel3) were added to commercially-available potting mix at 1 or 3% (w/w) and their effects on the growth stages (FIG. 20A), shoot FW (FIG. 20B) and leaf areas (FIG. 20C) of Choy sum were tested as shown. Results presented are means ±standard errors. Asterisk (*) above standard error bars indicate significance w.r.t. control (One-way ANOVA, Tukey's post-hoc test, p<0.05; n=7).

FIG. 21. Effect of various concentrations of Gel1 on the initial growth of the vegetable. Percentage of seedlings reaching the cotyledonary stage (inset) were recorded. Results presented are means=standard errors. Asterisk (*) above standard error bars indicate significance w.r.t. control (One-way ANOVA, Tukey's post-hoc test, p<0.05).

FIGS. 22A and 22B. Effect of Gel1 on the survival performance of Choy sum seedlings. The percentage of seedlings (n=20) survived were recorded on a daily basis (FIG. 22A) and representative seedlings grown in potting mix supplemented with 0-2% Gel1 ten days after sowing are presented (FIG. 22B).

FIGS. 23A to 23D. Effect of Gel1 at 2% on the growth of Choy sum under water-limiting conditions. Growth assessment were determined by looking at the shoot FW (FIG. 23A) and total leaf area per plant (FIG. 23B) and percentage increase was determined as shown (FIG. 23C). (FIG. 23D) Representative shoots of seedlings grown at 0 (top panel) or 2% (bottom panel) Gel1. Results presented for (FIG. 23A and FIG. 23B) are means ±standard errors. Asterisk (*) above standard error bars indicate significance w.r.t. control (Student's t-test, p<0.05; n=20).

FIG. 24. Synthetic scheme illustrating steps of making crosslinked poly(Okara-co-AA/NaAA-co-AAm) water-absorbent hydrogel. Reagents and conditions used: (i) ammonium persulfate (APS), heat to generate okara macroradical; (ii) acrylic acid (AA)/NaAA, acrylamide (AAm) and N,N′-methylenebisacrylamide (MBA).

FIG. 25. Synthetic scheme showing carboxymethylation of Ok(01) and Ok(01)-I via chloracetic treatment in alkali using three routes. Reagents used: (a) NaOH, water, IPA, followed by purification by methanol; (b) NaOH, water; (b1) purification by methanol; (b2) no purification by methanol.

### DESCRIPTION

As discussed above, there remains a need for super absorbent materials with better properties that are both biodegradeable and may also contain nutrients that may benefit the growth of plants. It has been surprisingly found that superabsorbent polymers that incorporate okara improve the growth of plants (for example, Choy sum seedlings). This means that plants grown in a medium supplemented with the gel may grow significantly faster, taller and/or with bigger leaves, as compared to plants grown without the gel. The gel may improve the survival capability of plants in drought conditions (when the gel is hydrated before or during). This means that seedlings/plants grown in a medium supplemented with the gel and without water are able to survive for a longer period of time than those without the gel and water.

Thus, there is disclosed a superabsorbent hydrogel comprising a crosslinked polymeric network comprising polymeric chains grafted onto particles of okara, wherein the crosslinks are formed through the polymeric chains and/or each okara particle being bonded to one or more polymeric chains.

In embodiments herein, the word “comprising” may be interpreted as requiring the features mentioned, but not limiting the presence of other features. Alternatively, the word “comprising” may also relate to the situation where only the components/features listed are intended to be present (e.g. the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa.

When used herein, the term “superabsorbent hydrogel” refers to a polymeric material with that is capable of absorbing a liquid (e.g. water) that has crosslinks. In this case, the crosslinks may exist between the polymeric chains and/or through multiple chains being anchored to more than one okara particle. Both of these forms of connection may exist in the superabsorbent polymers that are described herein, though in certain embodiments only one or the other of these forms of connection may exist.

When crosslinks exist between polymeric chains, this means that the polymeric chains are linked to one another by a crosslinking group that is not an okara particle. For example, the crosslinking group may refer to a moiety that covalently links at least two (e.g. 2, 3, 4, or 5) polymeric chains together. In this case, the originating compound has at least two (e.g. 2, 3, 4, or 5) functional groups that are capable of forming such covalent attachments. Such crosslinking groups may be incorporated into the polymeric backbone, as is the case for N,N′-methylenebisacrylamide (where the two C═C double bonds of the parent molecule react with growing polymeric chains to crosslink two molecules together), or may react with pendant functional groups on a pre-formed polymer (e.g. an alkyl polyol having two, three or four hydroxyl groups reacting with carboxylic acid side-chains on individual polymeric chains of polyacrylic acid to form the crosslink via the formation of ester bonds).

When the okara is central to the crosslinking, each okara particle may be covalently bonded to a plurality of polymeric chains, which chains are in turn attached to further okara particles, thereby providing a crosslinked polymeric network.

In certain embodiments, only one or the other of these possible crosslinking arrangements occurs. However, both crosslinking arrangements may be used in particular embodiments.

Okara when used herein refers to the insoluble parts of the soybean that remains after pureed soybeans are filtered in the production of soy milk and tofu. It is generally white or yellowish in colour. When moisture free, the okara may contain from 8 to 15 wt % fats, from 12 to 14.5 wt % crude fiber and 24 wt % protein. The okara may also contain potassium, calcium, niacin and soybean isoflavones, as well as vitamin B and the fat-soluble nutritional factors, which include soy lecithin, linoleic acid, linolenic acid, phytosterols, tocopherol, and vitamin D. The okara may be used as-is (subject to grinding, if necessary) as unfractionated okara particles or may be separated into water-insoluble okara particles, and water-soluble okara particles, using the conditions described in the experimental section below.

As noted above, the superabsorbent polymers may already contain compounds that are beneficial to the growth of plants. However, it is possible to enhance the nutritive effect by the addition of further plant nutrient materials. Any suitable plant nutrient materials may be added, which include, but are not limited to urea and the like. For example, other substances knows to supply nitrogen alone (“N-fertilisers”), phosphorous alone (“P-fertilisers”), potassium alone (“K-fertilisers”), or any combination thereof whether in a single substance or multiple substances (e.g. NP-fertilisers, NK-fertilisers, PK-fertilizers, NPK-fertilisers). Other substances that may be mentioned as plant nutrients herein include bio-fertilisers.

Any suitable polymer may be used in the polymeric chains described herein, provided that they are capable of being grafted onto particles of okara. When used herein, the term, “grafted onto particles of okara” refers to the ability of a polymeric chain to form a covalent bond with okara. This covalent bond may be formed through functionality present in the fully-formed polymeric chain (with functional groups already present on okara or with a pre-functionalised okara particle (e.g. carboxylated okara)), or may be formed by the presence of okara (e.g. by forming a macroradical of okara and reacting it with monomers or a polymeric chain that has not been chain-terminated). Both of these options are described in more detail hereinbelow and in the examples section. Suitable polymers that may be mentioned herein include, but are not limited to poly(acrylic acid), poly(acrylamide), polyethylene glycol, and copolymers thereof.

In certain embodiments of the invention, the polymeric chains may be formed from poly(acrylic acid), poly(acrylamide), or, more particularly, copolymers thereof (i.e. poly(acrylamide-co-acrylic acid). In such embodiments, the superabsorbent hydrogel may be formed by the polymerising monomeric acrylic acid and/or monomeric acrylamide (and/or non-chain terminated polymeric chains of said materials) in the presence of both okara particles and a suitable crosslinking agent, which may directly form crosslinks between the polymeric chains. For example, the crosslinks formed through the polymeric chains may be derived from a bisacrylamide crosslinking agent. Any suitable bisacrylamide crosslinking agent may be used. For example, the bisacrylamide crosslinking agent may be N, N′-methylenebisacrylamide. As will be appreciated, the degree of crosslinking between the polymeric chains will be determined by the amount of the crosslinking agent added to the reaction mixture. For example, the residual crosslinking agent material may form from 0.010 to 2 dry wt % of the hydrogel, such as from 0.1 to 1 dry wt %, such as from 0.16 to 0.34 dry wt %.

In embodiments where the polymeric chains have been formed from poly(acrylic acid), poly(acrylamide), or copolymers thereof, the okara particles may form from 15 to 50 dry wt % and the polymeric chain may form from 50 to 85 dry wt % of the hydrogel. For example, the hydrogel may contain from 25 to 40 dry wt % of okara particles and from 60 to 75 dry wt % of polymeric chain, such as from 25 to 40 dry wt % okara particles and from 60 to 75 dry wt % of polymeric chain, such as from 30 to 34 dry wt % of okara particles and from 66 to 70 dry wt % of polymeric chain.

As will be appreciated, polymers that contain acrylic acid will contain a polymeric backbone with pendant carboxylic acid groups. When the polymeric chains contain pendant carboxylic acid groups, the carboxylic acid groups may be wholly in the protonated form (excepting normal equilibration in neutral solution), wholly in a deprotonated form (i.e. a salt form with any suitable metal ion counterion, such as sodium, in the dry state) or they may be partially neutralised form. When used herein, the term “partly neutralised form” means that a proportion of the carboxylic acid groups in the polymeric chain has been deprotonated and exists in the salt form when in a dry state. For example, the proportion of carboxylic acid groups that may be deprotonated may be from 10 to 90%, such as from 20 to 75%, such as from 30 to 50%, such as 40%.

For the avoidance of doubt, when a list of numerical ranges is provided herein, any higher and lower values from these lists may be combined to provide new ranges. For example, from the values directly above, there is provided the following additional ranges: from 10 to 20%, from 10 to 30%, from 10 to 40%, from 10 to 50%, from 10 to 75%, from 20 to 30%, from 20 to 40%, from 20 to 50%, from 20 to 90%, from 30 to 40%, from 30 to 75%, from 10 to 90%, from 40 to 50%, from 40 to 75%, from 40 to 90%, from 50 to 75%, from 50 to 90%, and from 75 to 90%.

As noted above, in particular embodiments of the invention, the polymeric chains may be a copolymer of acrylic acid and acrylamide (crosslinked by a crosslinking agent). In such embodiments, the weight to weight ratio of acrylic acid to acrylamide in the polymeric chains may be from 1:10 to 10:1, such as from 3:7 to 7:3, such as 7:3.

In the above embodiments, when the hydrogel is formed from poly(acrylic acid), poly(acrylamide) or copolymers thereof, the resulting hydrogel may have an equilibrium swelling value of from 90 to 500 at a pH value of around 7. The tests associated with determining the equilibrium swelling value are provided in the experimental section hereinbelow.

As will be appreciated, in embodiments that make use of poly(acrylic acid), poly(acrylamide) or copolymers thereof that are grafted to okara particles, there may exist crosslinks between the polymer chains (as described above), but also crosslinks through the okara particles themselves. This is because each okara particle may be bonded to more than one of said polymeric chains.

Embodiments that make use of poly(acrylic acid), poly(acrylamide) or copolymers thereof may be formed using a method comprising the steps of:
(a) providing an aqueous suspension of okara;
(b) adding a radical initiator to the aqueous suspension to form a first reaction mixture that was aged for a first period of time;
(c) adding acrylic acid and/or acrylamide with a crosslinking agent to the first reaction mixture to form a second reaction mixture that was aged for a second period of time to form the superabsorbent hydrogel.

For completeness, it is noted that the acrylic acid and/or acrylamide added may also contain non-chain terminated polymeric (or copolymeric) materials, as discussed above. The crosslinking agent may be any of those described hereinabove. Any suitable ratio of the reagents may be used. In particular, the amount of each reagent used, may be selected to provide the ratios of okara, the polymeric chains and the crosslinker groups described above, which may be readily determined by a person skilled in the art by extrapolation from the examples provided hereinbelow.

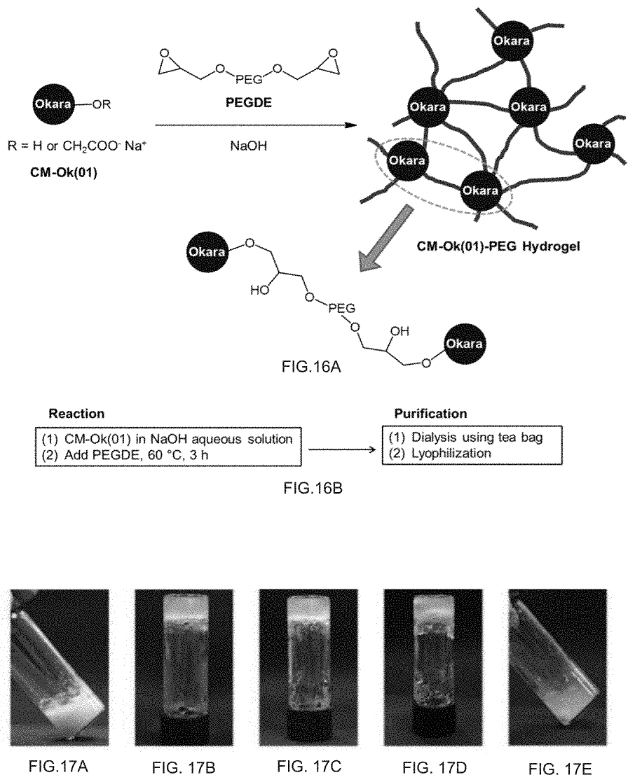

In alternative embodiments of the invention, the crosslinking present may be primarily through the okara particles. That is multiple polymeric chains may be attached to a single okara particle, each of which chains as then linked to a further okara particle, resulting in a polymeric network as shown in cartoon form in FIGS. 16A and 16B. In such embodiments, the hydrogel may be formed by the reaction of carboxylated okara particles that comprise one or more carboxylic acid functional groups with polymeric chains that comprise two or more epoxide groups, where an ester linkage is formed by reaction of a carboxylate group with an epoxide. When used herein, the term “carboxylate group” may refer to a carboxylic acid or, more particularly, to a deprotonated carboxylic acid group. Any suitable polymeric chain that has two or more (e.g. 2, 3, 4, or 5) epoxide groups may be used in embodiments where okara is the primary crosslinker. For example, a suitable polymer may be polyethylene glycol diglycidyl ether. In such embodiments, the weight to weight ratio of carboxylated okara to polymeric chains that comprise two or more epoxide groups may be from 1:2 to 2:1, such as from 1:1.2 to 1:0.6. Further, in such embodiments, the hydrogel may have an equilibrium swelling value of from 10 to 110. The equilibrium swelling value may be measured using ordinary tap water. As such, the pH value of the water may range from 6.5 to 8.5.

The above superabsorbent hydrogels where okara is used to provide the crosslink may be formed using a method comprising the steps of:
(a) providing an aqueous suspension of carboxylated okara in an alkaline aqueous solution; and
(b) adding a polymeric chain material that has two or more epoxide groups to the aqueous suspension to react with the carboxylated okara to form the superabsorbent hydrogel. Further details of said reaction are provided in the examples section below.

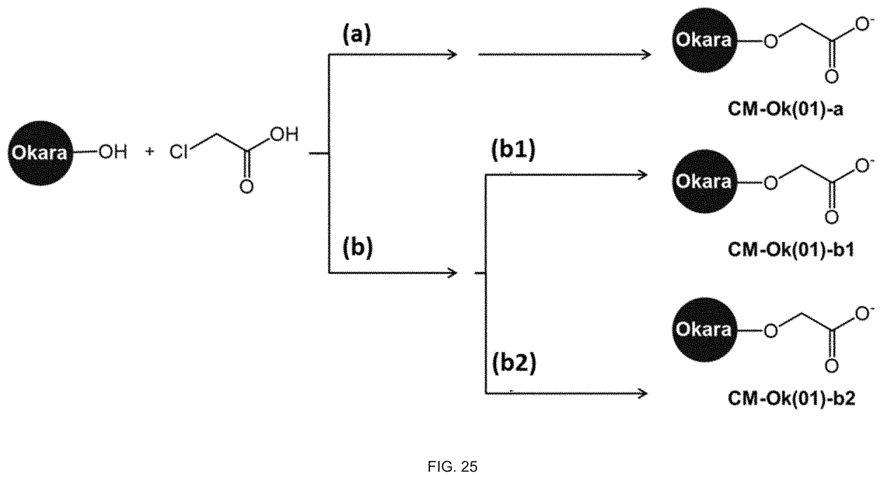

Carboxylated okara may be obtained through the reaction of okara with an alkyl halide bearing a carboxylic acid group, which is discussed in more detail in the examples herein below, with reference to FIG. 25. Any suitable ratio of the reagents may be used. In particular, the amount of each reagent used, may be selected to provide the ratios of okara and polymeric chains described above, which may be readily determined by a person skilled in the art by extrapolation from the examples provided hereinbelow.

As will be appreciated from the above, the superabsorbent hydrogels disclosed herein may be used in agriculture. For example, the super absorbent hydrogels may be used alone, or in combination with other materials as an aid to plant growth and maintenance of sufficient water supply to a plant. For example, the hydrogels may be impregnated with an aqueous solution containing urea, thereby trapping water, which may be released over a period of time to the plant, along with the urea and other nutrients inherently included within the composition (i.e. from the okara particles as described above).

In such uses, the superabsorbent hydrogel may be provided as part of a composite material. More particularly, the current invention also relates to a composite material for use in growing plants, comprising a soil and a superabsorbent hydrogel as discussed above.

The superabsorbent hydrogel may be provided in any suitable amount as part of the composite material. For example, in embodiments where the composite material is applied to the germination of seeds or vegetable seedlings, the composite material may contain an amount of from 0.5 to 10 dry wt % of the hydrogel, such as from 1 to 5 dry wt %, such as from 2 to 3 dry wt %.When used herein with reference to the composite material, the term “dry wt %” refers to the proportions of the constituent components (i.e. soil and hydrogel) in the composite material once water has been removed (e.g. the composite is dried and weighed periodically until the weight remains constant). It will be appreciated that the actual amount of hydrogel incorporated into the composite material may vary depending on the intended use. For example, if intended for use with a larger plant, such as a fruit tree or the like, the composite material may contain from 1 to 95 dry wt %, such as from 10 to 75 dry wt %, such as from 15 to 50 dry wt %, such as 20 to 40 dry wt % of the hydrogel.

In composite material is particularly suited to holding a great amount of water, which may be quantified as a water holding percentage (discussed in more detail in the experimental section below). In embodiments of the invention, where the composite material contains from 0.5 to 10 dry wt % of hydrogel, the water holding percentage of the composite material may be from 125 to 250%, such as from 145 to 230%, such as from 175 to 225%. As will be appreciated, increasing the amount of superabsorbent hydrogel in the composite material will also result in an increased water holding percentage in a substantially directly proportional fashion. As such, significantly increased water holding percentages for the composite materials disclosed herein would be expected for composite materials that contain more than 10 dry wt % of the hydrogel.

As indicated above, the hydrogel component may be impregnated before inclusion in the composite material with a plant nutrient (e.g. urea). In use, the hydrogel will then release the absorbed nutrient to the plant over a period of time, which may cause the plant to grow better and/or be more healthy than a plant not subjected to such additional nutrition. In addition, it is noted that the okara may itself contribute to the growth and/or health of a plant due to the inherent nutrients contained within said okara particles.

The release rate of the plant nutrient may take place over a period of hours, weeks, or in cases where a substantial proportion of impregnated hydrogel is used, months. For example, the plant nutrient may be released from the composite material over a period of from 3 to 20 days, such as from 4 to 18 days, such as from 10 to 15 days, such as 14 days in accordance with the tests described in the experimental section below.

As will be appreciated, the superabsorbent hydrogels disclosed herein contain okara and polymers, which components degrade over time through physical degradation (e.g. exposure to heat, light, water etc) and/or biological degradation (e.g. through the action of microorganisms). Thus, the superabsorbent hydrogels disclosed herein will also break down over time into further components that may be beneficial to the nutrition of the plant and so also avoids the build-up of plastic waste in the environment.

Further aspects and embodiments of the invention are provided in the following non-limiting examples.

### EXAMPLES

### Example 1

### Grafting of Polvacrylic Acid on Okara-Based Materials

Okara-based graft copolymers, e.g. Ok(01)-PAA and Ok(01)-I-PAA were synthesized via graft polymerization.

Method

In a typical example, dried Ok(01)-I (the water-insoluble fraction of Okara) was added to water to prepare 7.5 wt % aqueous suspension which was homogenized by IKA T50 digital Disperser. 48 g of 7.5 wt % Ok(01)-I suspension (contain Ok(01)-I 3.6 g) was put in a 250-mL three-necked flask equipped with a mechanical stirrer and a nitrogen line. The suspension was purged by nitrogen gas (N₂) for 15 min, and then heated to 70° C. under N₂ flow for another 15 min. The initiator APS (144 mg) was then added and the temperature maintained at 70° C. under N₂ flow. After 30 min, 7.2 g of AA in 16.6 mL water was added. The reaction was kept at 70° C. under N₂ atmosphere for 5 h. The resulting product (named as Ok(01)-I-PAA) was suspended in water and centrifuged at 11000rpm for 20 min. The precipitates were collected and washed by water and freeze-dried, which was named as Ok(01)-I-PAA precipitates. The supernatant was freeze-dried and named as Ok(01)-I-PAA supernatant.

Homopolymers (controls for comparison), e.g. PAA and PAAm were synthesized by the same method, which was used for producing okara-based graft copolymers, in the absence of okara. In a typical example, 48 g water was put in a 250-mL three-necked flask equipped with a mechanical stirrer and a nitrogen line. The water was purged by nitrogen gas (N₂) for 15 min, and then heated to 70° C. under N₂ flow for another 15 min. The initiator APS (144 mg) was then added and the temperature maintained at 70° C. under N₂ flow. After 30 min, 7.2 g of AA in 16.6 mL water was added. The reaction was kept at 70° C. under N₂ atmosphere for 5 h. The resulting product was freeze-dried and named as PAA (control of 1:2).

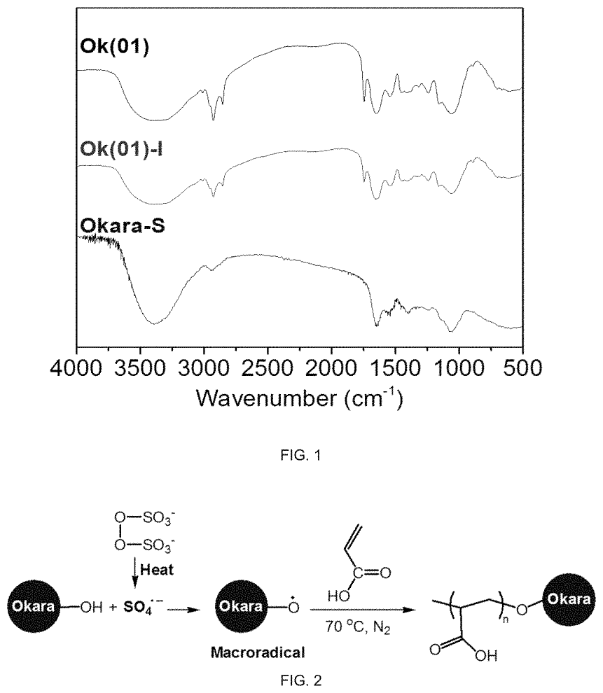

The synthetic routes of Ok(01)-I-PAA were shown FIG. 2. The okara macroradicals were obtained by generating radicals on okara via heating of initiator APS, followed by graft polymerization of AA monomers onto okara. The resulting product was precipitated in DI water. The precipitates were collected and washed by water and freeze-dried, which was named as Ok(01)-I-PAA precipitates. The supernatant was found to be turbid, which was freeze-dried and named as Ok(01)-I-PAA supernatant. The precipitates and supernatant content were estimated to be 41.9 wt % and 58.1 wt %, respectively. The yield of precipitates (41.9 wt %) was higher than the feeding content of Ok(01)-I which was 33.3 wt %, indicating some PAA was grafted on Ok(01)-I and precipitated.

¹H NMR spectra were obtained at room temperature on a Bruker Avance DRX 400 MHz NMR spectrometer operating at 400 MHz. Chemical shifts are reported in ppm with reference to solvent peak (CHC1₃: 5 7.26 ppm for ¹H NMR).

Fourier transform infrared (FTIR) spectra of polymers in KBr were recorded on a Perkin-Elmer FTIR 2000 spectrometer in the region of 4000-500 cm⁻¹.

Microscope images were taken on an Olympus IX51 Inverted Microscope with a DP25 camera.

Dynamic rheological measurements were performed on a HAAKETM MARS III Rotational Rheometer with parallel plate geometry (35 mm diameter) at a gap of 1 mm. Samples were carefully loaded onto the measuring geometry and water was added around the measuring geometry to minimize the effect of water evaporation on the rheology data. Oscillatory time sweeps were performed at a constant shear stress of 1.0 Pa and a fixed frequency of 1.0 Hz at 25° C. Oscillatory stress sweeps were performed by applying increasing shear stress logarithmically from 0.1 Pa at a constant frequency of 1.0 Hz at 25° C., until the hydrogels were destroyed, as evidenced by a G′/G″ crossover, and 100% deformation was reached. Oscillatory frequency sweeps were performed from 0.1 to 100 Hz at a constant shear stress of 1.0 Pa at 25° C.

The shear viscosity was measured by applying increasing shear rate logarithmically from 0.1 Pa to 100 Pa at 25° C.

Characterization

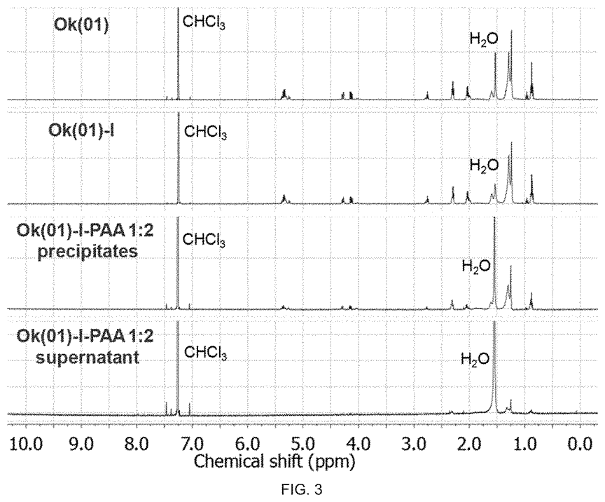

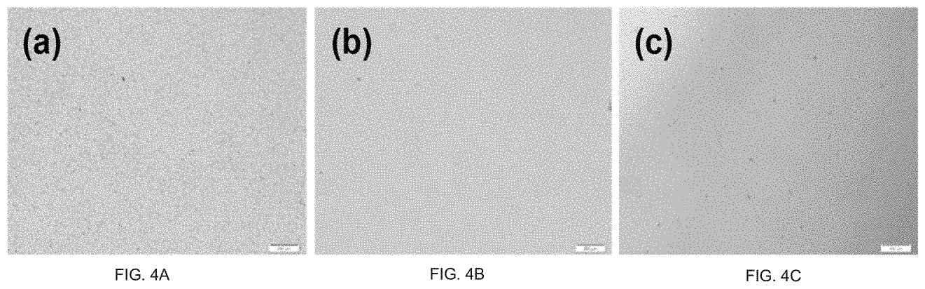

The ¹H NMR spectra of Ok(01), Ok(01)-I, Ok(01)-I-PAA 1:2 precipitates and Ok(01)-I-PAA 1:2 supernatant in CDC1₃ were shown in FIG. 3. The characteristic peaks of Ok(01)-I were clearly seen in Ok(01)-I-PAA precipitates. As PAA is not soluble in CDCl₃, so PAA peak was not found in the spectrum. It is noted that Ok(01)-I-PAA 1:2 supernatant also showed characteristic peaks of Ok(01)-I, indicating that the supernatant also contains some Ok(01)-I. The presence of Ok(01)-I in the supernatant was further demonstrated by observing many small particles from microscopic images of Ok(01)-I-PAA 1:2 supernatant, as shown in FIG. 4A. Only Ok(01)-I-PAA 1:2 supernatant showed the presence of small particles, which were absent in both PAA (control of 1:2) supernatant and Ok(01)-I supernatant. It is believed that the small particles are PAA grafted Ok(01)-I, which are more likely to suspend in water than Ok(01)-I itself but cannot dissolve in water to behave like PAA solution.

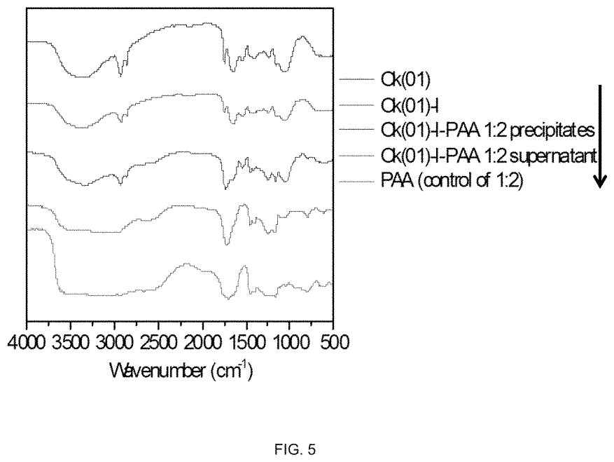

The successful grafting of PAA on Ok(01)-I was evidenced by FT-IR spectra shown in FIG. 5. Ok(01)-I-PAA 1:2 precipitates showed obvious signals from both Ok(01)-I and PAA.

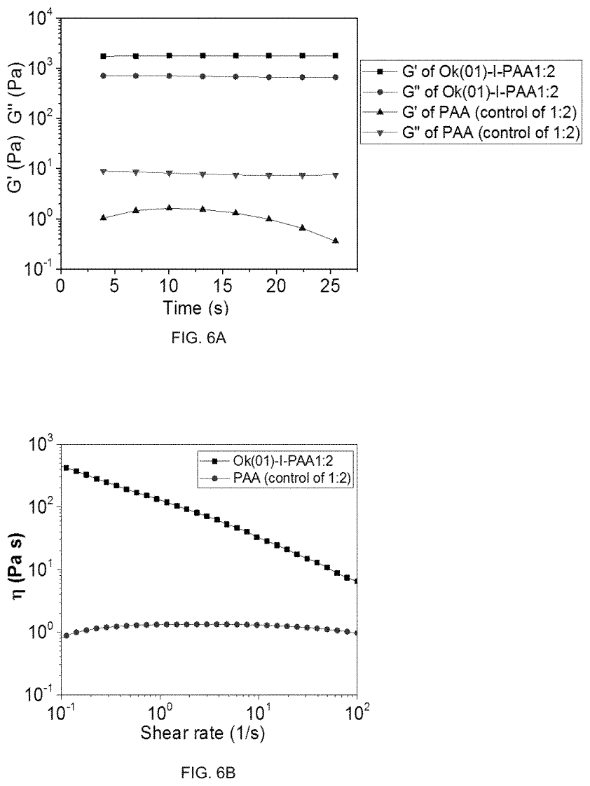

The successful grafting of PAA on Ok(01)-I was further demonstrated by the rheological measurements of Ok(01)-I-PAA 1:2 and PAA (control of 1:2) shown in FIGS. 6A and 6B. Storage modulus G′ (elastic response) and loss modulus G″ (viscous behavior) of Ok(01)-I-PAA 1:2 and PAA (control of 1:2) were tested. Material is considered to be more liquid-like when G″>G′, while G′>G″ indicates the material is more solid-like. As can be seen in FIG. 6A, Ok(01)-I-PAA 1:2 is much more solid-like than PAA (control of 1:2). It can be explained that Ok(01)-I contains multiple hydroxyl groups on the surface, leading to much higher molecular weight polymers when PAA grafted onto it. High molecular weight Ok(01)-I-PAA 1:2 polymer chains were entangled to exhibit gel behavior. The Shear Viscosity Vs. Shear Rate curve shown in FIG. 6B indicated Ok(01)-I-PAA 1:2 is a visco-elastic gel and PAA (control of 1:2) is a newtonian fluid. Ok(01)-I-PAA 1:2 exhibited shear thinning behavior, which was attributed to the deformation of disentanglement of the polymer chains at high shear load.

### Example 2

### Crosslinking of Grafted Okara-Based Material Enhances Water Absorbancy

Okara-based graft copolymer gels, e.g. Ok(01)-PAA Gel and Ok(01)-P(AA-co-AAm) were synthesized using the same method for producing Ok(01)-I-PAA (see Example 1), with modification of adding crosslinker MBA.

Method

Fresh Ok(01) was added to water to prepare 7.5 wt % Ok(01) aqueous suspension which was homogenized by IKA T50 digital Disperser. 48 g of 7.5 wt % Ok(01) suspension (contain Ok(01) 3.6 g) was put in a 250-mL three-necked flask equipped with a mechanical stirrer and a nitrogen line. The suspension was purged by nitrogen gas (N₂) for 15 min, and then heated to 70° C. under N₂ flow for another 15 min. The initiator APS (144 mg) was then added and the temperature maintained at 70° C. under N₂ flow. After 30 min, predetermined amounts of AA and crosslinker MBA in water were added. The reaction was kept at 70° C. under N₂ atmosphere for 5 h. The resulting product was freeze-dried and milled.

The synthesis of Ok(01)-I-PAA Gel1-2 at various MBA concentrations was shown in Table 1. The resulting gels were milled to powders and put in tea bags for swelling test.

The swelling test of the prepared gels was performed by tea bag method. 100 mg of dry gel particles were weighed and put into pre-weighed and pre-wetted tea bags. The gels in tea bags were then soaked in the swelling medium at room temperature for 24 hr to reach the swelling equilibrium. Finally, the tea bags were removed from the swelling medium and hung up for 15 min and then blot dried by filter paper to remove the excess fluid and weighed.

Swelling ratio, Q=(W−W₀)/W₀

Equilibrium swelling, Q_{eq}=(W_{eq}−W₀)/W₀

W: weight of swollen sample; W₀: weight of dry sample; W_{eq}: weight of swollen sample after achieving equilibrium.

Results

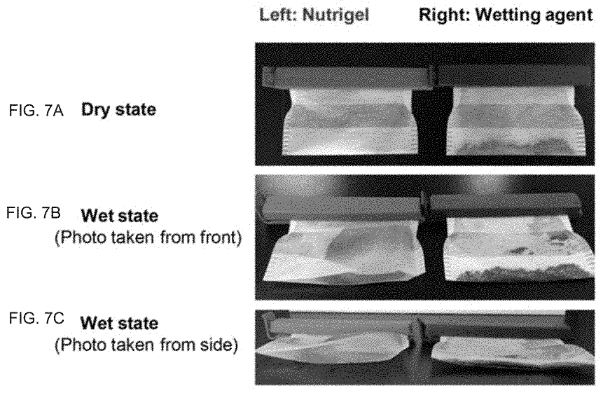

The equilibrium swelling of Ok(01)-I-PAA Gel1-2_MBA0.05, Ok(01)-I-PAA Gel1-2_MBA0.1, Ok(01)-I-PAA Gel1-2_MBA0.2 in water at different pH conditions were shown in Table 2. The commercially available wetting agent was from a local farm. The preliminary results showed that the Ok(01)-I-PAA Gel1-2 had better water absorbency than the wetting agent, which also can be seen from photos in FIGS. 7A to 7C.

TABLE 1
Synthesis of Ok(01)-I-PAA Gel1-2 at various MBA concentrations.

| | Conc. of | Conc. of | Conc. of | Conc. of | Ratio of Ok(01) to | | Ok(01) |
|---|---|---|---|---|---|---|---|
| | AA | Ok(01) | MBA | APS | AA (wt/wt) | | content in |
| Gel code | (wt %) | (wt %) | (wt %) | (wt %) | Ok(01) | AA | the gel (wt %) |
| OK(01)-PAA Gel1-2_MBA_{0.05} | 10 | 5 | 0.05 | 0.2 | 1 | 2 | 33.3 |
| OK(01)-PAA Gel1-2_MBA_{0.1} | 10 | 5 | 0.1 | 0.2 | 1 | 2 | 33.3 |
| OK(01)-PAA Gel1-2_MBA_{0.2} | 10 | 5 | 0.2 | 0.2 | 1 | 2 | 33.3 |
| OK(01)-PAA Gel1-3_MBA_{0.05} | 10 | 3.33 | 0.05 | 0.2 | 1 | 3 | 25 |
| OK(01)-PAA Gel1-3_MBA_{0.1} | 10 | 3.33 | 0.1 | 0.2 | 1 | 3 | 25 |
| QK(01)-PAA Gel1-3_MBA_{0.2} | 10 | 3.33 | 0.2 | 0.2 | 1 | 3 | 25 |

TABLE 2
Equilibrium swelling of Ok(01)-I-PAA Gel1-2_MBA_{0.05},
Ok(01)-I-PAA Gel1-2_MBA_{0.1}, Ok(01)-1-PAA Gel1-2_
MBA_{0.2} in water at different pH conditions.

| | Q_{eq} at different pH | | |
|---|---|---|---|
| conditions Gel code | H₂O (pH 4.4) | H₂O (pH 6.9) | H₂O (pH 8.9) |
| OK(01)-PAA Gel1-2_MBA_{0.05} | 55.7 | 384.7 | 246.6 |
| OK(01)-PAA Gel1-2_MBA_{0.1} | 34.2 | 190.5 | 130.2 |
| OK(01)-PAA Gel1-2_MBA_{0.2} | 28.1 | 95.6 | 55.5 |
| Wetting agent | 5.3 | 6.4 | 6.0 |

### Example 3

### Crosslinking of Grafted Okara-Based Material Enhances Water Absorbancy

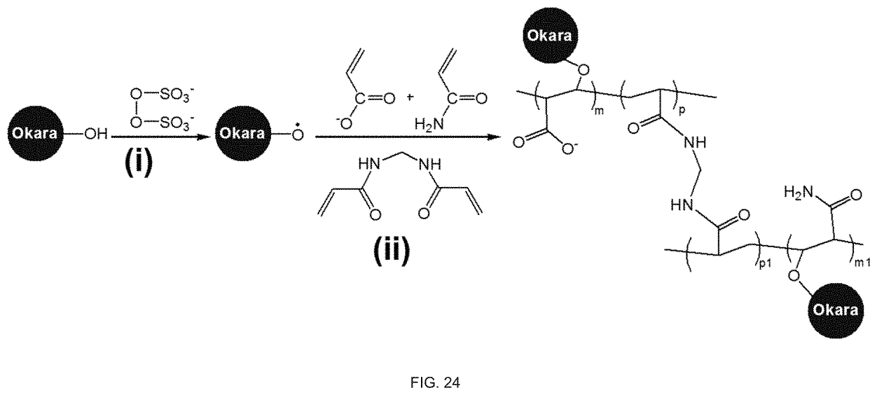

Okara-based graft copolymer gels, e.g. Ok(01)-PAA gel, Ok(01)-P(AA-co-AAm) gel and Ok(01)-P(AANa-co-AAm) gel were synthesized using the same method for producing Ok(01)-I-PAA, with modification of adding crosslinker MBA, AAm and partially neutralized AA (see FIG. 24). Specifically, the procedure of Example 2 was repeated and optimized by use of partially neutralized acrylic acid AANa (instead of acrylic acid) and addition of acrylamide (AM) as a copolymer, and the procedure was carried out at a larger scale.

Method

Fresh Ok(01) was added to water to prepare 7.5 wt % Ok(01) aqueous suspension which was homogenized by IKA T50 digital Disperser. 384 g of 7.5 wt % Ok(01) suspension (contains Ok(01) 28.8 g) was put in a 1 L three-necked flask equipped with a mechanical stirrer and a nitrogen line. The suspension was purged by nitrogen gas (N₂) for 30 min, and then heated to 70° C. under N₂ flow. The initiator APS (1.152 g) was then added and the temperature maintained at 70° C. under N₂ flow for 30 min to generate okara macroradical.

In a separate three-neck round bottom flask, water was added to acrylic acid. The mixture was cooled in an ice water bath. NaOH solution was dropped into the AA solution in ice water bath (with a neutralization of 40% by NaOH aqueous solution For avoidance of doubt, 40% neutralization means that for every 1 mole of AA, 0.4 moles of NaOH were added. The ice water bath was removed after addition of NaOH was completed. The resulting AANa solution was added with acrylamide (AAm) and N,N′-Methylenebisacrylamide (MBA) in predetermined amounts and bubbled with nitrogen gas for 30 min.

The mixture containing AAm, partially neutralized AA and crosslinker MBA in water were then added into okara macroradical. The reaction was kept at 70° C. under N₂ atmosphere overnight. The resulting product was freeze-dried and milled.

Swelling test was conducted with the protocol as in Example 2.

The synthesis of Ok(01)-P(AANa-co-AAm) gels varying in ratios of AANa to AAm was shown in Table 3. The resulting gels were milled to powders and put in tea bags for swelling test.

TABLE 3
Synthesis of Ok(01)-P(AANa-co-AAm) gels varying in ratios of AANa to AAm.

| | Conc. of | Conc. of | Conc. of | Conc. of | Conc. of | Ratio of Ok(01) to | | Ok(01) |
|---|---|---|---|---|---|---|---|---|
| | AANa, | AAm, | Ok(01), | MBA, | APS, | AANa + AAm (wt/wt) | | content in |
| Gel code | wt % | wt % | wt % | wt % | wt % | Ok(01) | AANa + AAm | the gel (wt %) |
| Ok(01)-P(AANa₇-co-AAm₃) | 7 | 3 | 5 | 0.05 | 0.2 | 1 | 2 | 33.3 |
| Gel1-2_MBA_{0.05} | | | | | | | | |
| Ok(01)-P(AANa₅-co-AAm₅) | 5 | 5 | 5 | 0.05 | 0.2 | 1 | 2 | 33.3 |
| Gel1-2_MBA_{0.05} | | | | | | | | |
| Ok(01)-P(AANa₃-co-AAm₇) | 3 | 7 | 5 | 0.05 | 0.2 | 1 | 2 | 33.3 |
| Gel1-2_MBA_{0.05} | | | | | | | | |

Results

The equilibrium swelling of Ok(01)-P(AANa₇-co-AAm₃) Gel1-2_MBA_{0.05}, Ok(01)-P(AANa₅-co-AAm₅) Gel1-2_MBA_{0.05}, and Ok(01)-P(AANa₃-co-AAm₇) Gel1-2_MBA_{0.05} in tap water were shown in Table 4. The swelling ratio of wetting agent from local farm was estimated to be around 7 in tap water, which is much lower than the Ok(01)-P(AANa-co-AAm) gels. The three gels were tested for plant growth (the results presented in Example 9). Gel1-2 A7M3B0.05 (Gel 1 at 3 wt %) was found to perform better than the other two gels.

TABLE 4
Equilibrium swelling of Ok(01)-P(AANa-co-AAm) gels in tap water.

| | | | Q_{eq} in tap |
|---|---|---|---|
| Gel code | Abbreviation | Sample ID | water |
| Ok(01)-P(AANa₇-co-AAm₃) | Gel1-2 A7M3B0.05 | Gel 1 | 189.5 |
| Gel1-2_MBA_{0.05} | | | |
| Ok(01)-P(AANa₅-co-AAm₅) | Gel1-2 A5M5B0.05 | Gel 2 | 182.4 |
| Gel1-2_MBA_{0.05} | | | |
| Ok(01)-P(AANa₃-co-AAm₇) | Gel1-2 A3M7B0.05 | Gel 3 | 145.2 |
| Gel1-2_MBA_{0.05} | | | |

### Example 4

### Effect of Crosslinker Concentration and Particle Size on Water Absorbency/Retention

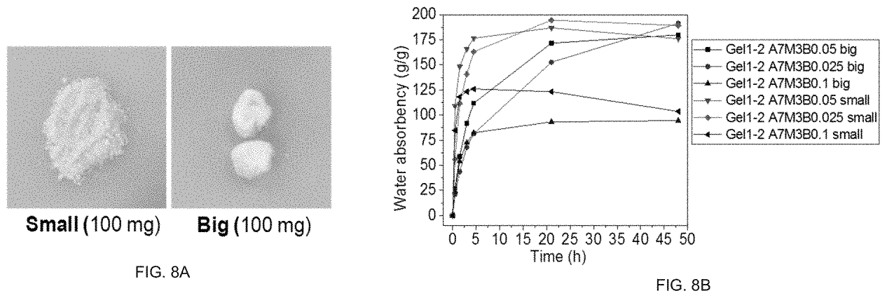

To investigate whether the water absorbency capacity of Ok(01)-P(AANa-co-AAm) gels can be further improved, Ok(01)-P(AANa₇-co-AAm₃) gels varying in concentrations of the crosslinker MBA were synthesized and shown in Table 5. The dried gels were milled to powders. The small and big powder particles were collected separately, aiming to investigate the effect of particle size on water absorbency and water holding and retention capacity. The pictures of small and big powder particles were shown in FIG. 8A. The particles were put in tea bags for swelling test and the water absorbency of the three Ok(01)-P(AANa₇-co-AAm₃) gels was presented in FIG. 8B. It was found that all the small gel particles'swelling rate is higher than big ones, but the small and big particles didn't show difference on equilibrium swelling. It is noted that the water absorbency of Ok(01)-P(AANa₇-co-AAm₃) Gel1-2_MBA_{0.1} is much lower than Ok(01)-P(AANa₇-co-AAm₃) Gel1-2_MBA_{0.025} and Ok(01)-P(AANa₇-co-AAm₃) Gel1-2_MBA₀₀₅, so further testing will focus on the latter two gels.

TABLE 5
Synthesis of Ok(01)-P(AANa₇-co-AAm₃) gels varying in concentrations of the crosslinker MBA.

| | Conc. of | Conc. of | Conc. of | Conc. of | Conc. of | Ratio of Ok(01) to | | Ok(01) |
|---|---|---|---|---|---|---|---|---|
| | AANa, | AAm, | Ok(01), | MBA, | APS, | AANa + AAm (wt/wt) | | content in |
| Gel code | wt % | wt % | wt % | wt % | wt % | Ok(01) | AANa + AAm | the gel (wt %) |
| Ok(01)-P(AANa₇-co-AAm₃) | 7 | 3 | 5 | 0.025 | 0.2 | 1 | 2 | 33.3 |
| Gel1-2_MBA_{0.025} | | | | | | | | |
| Ok(01)-P(AANa₇-co-AAm₃) | 7 | 3 | 5 | 0.05 | 0.2 | 1 | 2 | 33.3 |
| Gel1-2_MBA_{0.05} | | | | | | | | |
| Ok(01)-P(AANa₇-co-AAm₃) | 7 | 3 | 5 | 0.1 | 0.2 | 1 | 2 | 33.3 |
| Gel1-2_MBA_{0.1} | | | | | | | | |

### Example 5

### Soil added with Gel Particles Show Improved Water Holding and Retention

Water holding and water retention of soil with Ok(01)-P(AANa₇-co-AAm₃) gels was measured using method reported by Lü, S et. al., Journal of Agricultural and Food Chemistry 2016, 64 (24), 4965-4974. with some modifications.

Water-Holding Measurement methylenebisacrylamide. (1) Well-mixed mixtures of different amounts of gels (1 and 3 wt % of soil) and Wₛ gram of soil were carefully placed into pots with hole. The bottom hole of each pot was sealed with tea bag and weighed (defined as W₀); (2) Samples in the pots were soaked in tap water for 1 day. The pots were then taken out and the excess water at the bottom and outer wall was removed by tissues. The pots were weighed once more (defined as W₁). At the same time, the control treatment without any gel was carried out; (3) On the basis of W₀ and W₁, the value of water holding in the soil (Wₕ, refers to a saturated moisture of soil, which is the ratio of the total amount of moisture in the soil and the weight of soil when excess water is discharged by the effect of gravity) was calculated according to the equation below:

Wₕ%=[(W₁−W₀)/Wₛ]*100

Water Retention Measurement

The above procedures were immediately followed by the study of water-retention capacity of soil containing gels. Throughout the experiment, the treatments were maintained at room temperature and samples were weighed every day for 1 month (defined as Wₜ). The dry weight was defined as W_{dry} when a constant weight had been reached. The value of water retention (Wᵣ) was calculated according to the equation below:

Wᵣ%=[(Wₜ−W_{dry})/(W₁−W_{dry})]*100

Results

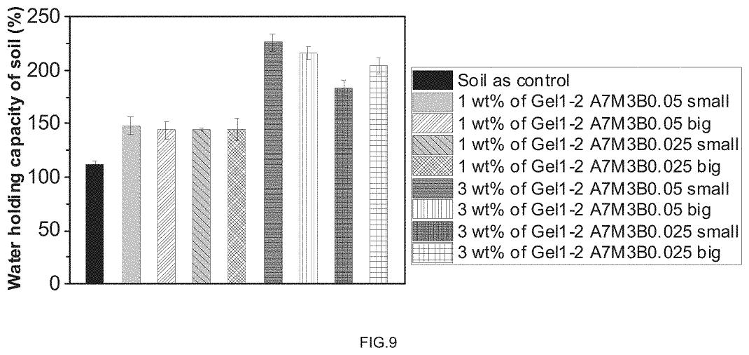

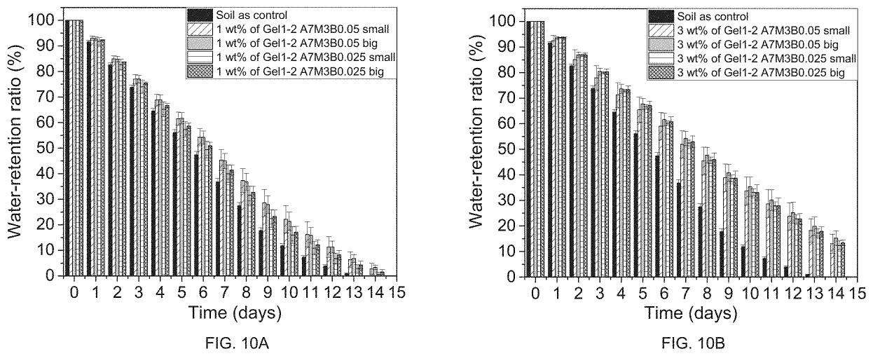

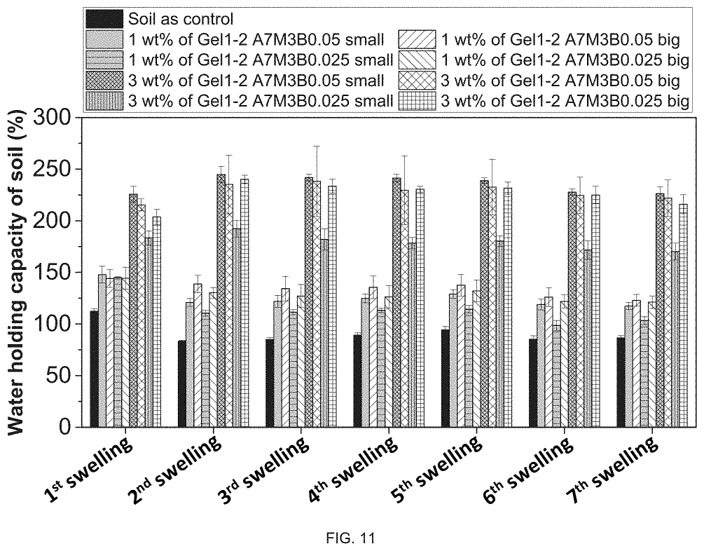

The water holding and retention capacity of soil containing gel particles (1 and 3 wt % of soil) were shown in FIG. 9 and FIGS. 10A and 10B. Soil containing gel particles (1 and 3 wt % of soil) showed improved water holding and retention capacity, with P(AANa₇-co-AAm₃) Gel1-2_MBA_{0.05} (3 wt % of soil) showing the best performance. Small and big gel particles did not show significant difference. Reswelling capacity of the gels was tested and the results were shown in FIG. 11. Reswelling experiment was carried out when the samples became dry. The dried samples in the pots were first soaked in tap water for 1 day. The pots were then taken out and the excess water at the bottom and outer wall removed by tissues before the pots were weighed and the water holding capacity of the samples calculated. As can be seen from FIG. 11, the water holding capacity of soil containing gel particles (3 wt % of soil) remained comparable even after 7 cycles of wetting and drying. Based on the results, the P(AANa₇-co-AAm₃) Gel1-2_MBA_{0.05} gel (small particles) were further tested for plant growth (the results presented in Example 9).

### Example 6

### Urea-Loaded Gel Shows Sustained Release in Soil

To prepare urea-loaded gel, 1.2 g of P(AANa₇-co-AAm₃) Gel1-2_MBA_{0.05} gel powders were immersed in 600 mL urea solution (0.2 wt % in tap water) overnight. The swollen gel was freeze-dried to obtain urea-loaded gel. The urea concentration was measured using method reported by Watt, G. W. et al. Analytical Chemistry 1954, 26 (3), 452-453 with some modifications. Spectrophotometric determination of urea was based upon the yellow-green color produced when p-dimethylaminobenzaldehyde was added to urea in dilute hydrochloric acid solution. The color reagent used consisted of: p-dimethylaminobenzaldehyde (0.2 g), 96% ethanol (10 ml), and concentrated hydrochloric acid (1 ml). In this experiment, 40 μL of color reagent was added to 60 pL urea solution. After 15 min of incubation, the absorbance scan over the 420-460 nm range was recorded (Tecan Infinite M200 PRO Microplate Reader). The wavelength used for quantification was 440 nm. The urea loading content was determined to be 29.5%.

The urea release experiment was carried out with the system described as follows. Total amount of soil or NUSoil is 8 grams, i.e. control sample contains 8 g soil; soil with urea-loaded gels (1 wt % of soil) contains 7.92 g soil and 0.08 g Nutrigel; soil with urea-loaded gels (3 wt % of soil) contains 7.76 g soil and 0.24 g Nutrigel.

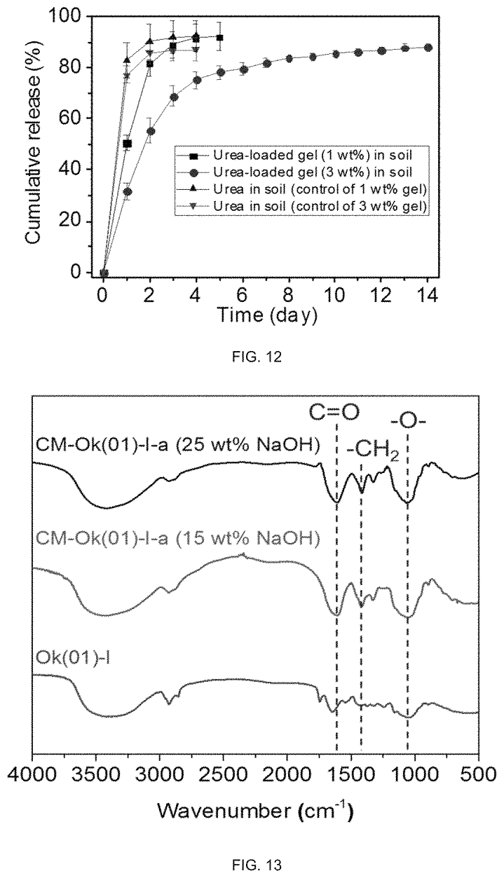

The urea-loaded gel was mixed with commercial soil to obtain a product, which was called NUSoil. Equivalent amount of urea powder was mixed with commercial soil to be used as control. The commercial soil or soil containing gel (NUSoil) was placed into a pot containing a hole at the base of the pot. The pot was placed above a beaker and the beaker was shaken at 30 rpm. Tap water was given by a syringe pump at a flow rate of 5 mL/min for 8 mins/day to give a total of 40 mL/day to the soil. The cumulative release curve of urea from soil or NUSoil was shown in FIG. 12. It was found that soil with urea-loaded gels (1 and 3 wt % of soil) can sustain release till 4 days and 14 days, respectively. In contrast, the equivalent amount of urea powder in the commercial soil was almost released within 2 days. Urea-loading and release from Nutrigel was thus being optimized, with an apparent slowing down of the initial burst of release being observed.

### Example 7

### Carboxylmethylation of Okara-Based Materials

Carboxymethylated okara-based polymers, e.g. carboxymethylated Ok(01) (CM-Ok(01)) and carboxymethylated Ok(01)-I (CM-Ok(01)-I), were synthesized. The protocols were adapted and further developed from the reported protocols for synthesis of carboxymethyl cellulose (CMC) (see Haleem, N et. al., Carbohydrate Polymers 2014, 113, 249-255 and Rachtanapun, P. et. al., Journal of Applied Polymer Science 2011, 122 (5), 3218-3226).

In brief, okara-based polymers were dispersed in a mixture of water and 2-propanol in different ratios ranging from 0:100 to 100:0. Alkali, such as sodium hydroxide (NaOH), with various concentrations (e.g. 15, 25 and 35 wt %) was added and stirred at room temperature for predetermined period of time. Various amounts of chloroacetic acid were added to the reaction mixture. After reaction at high temperature, the product was purified.

Three routes of making carboxymethylated okara are described as follows and illustrated in FIG. 25.

Route (a)

In a typical example of route (a), 2 g of Ok(01) or Ok(01)-I was dispersed in 120 mL of water:2-propanol (1:4 v/v) in a beaker and stirred at room temperature. 16 mL of 15 wt % NaOH aqueous solution was added dropwise over a period of 30 min. The mixture was stirred at 500 rpm at room temperature for another 1.5 h. Then, 2 g of chloroacetic acid was added to the reaction mixture and stirred for 30 min. The mixture was then heated to 55° C. and stirred for another 3 h. After the reaction, the liquid phase was removed and the solid phase was suspended in 40 mL methanol for 40 min while stirring. Excess alkali was neutralized with acetic acid. The product CM-Ok(01)-a or CM-Ok(01)-I-a was collected by centrifugation, and the pellet was washed with methanol for three times and dried in vacuum overnight at 60° C. The yield of CM-Ok(01)-I-a was 1.2 g, 1.1 g and 0.8 g when the concentration of NaOH used was 15, 25 and 35 wt %, respectively. The yield of CM-Ok(01)-a was 1.1 g and 1.0 g when the concentration of NaOH used was 15 and 25 wt %, respectively.

Route (b1)

In a typical example of route (b1), 2 g of Ok(01) was dispersed in 24 mL of water and another 16 mL of 15 wt % NaOH aqueous solution in a beaker. The mixture was stirred at 500 rpm at room temperature for 2 h. Then, 2 g of chloroacetic acid was added to the reaction mixture and stirred for 30 min. The mixture was then heated to 55° C. and stirred for another 3 h. After the reaction, the mixture was suspended in 40 mL methanol for 40 min while stirring. The product CM-Ok(01)-b1 was collected by centrifugation and dried in vacuum overnight at 60° C.

Route (b2)

In a typical example of route (b2), 2 g of Ok(01) was dispersed in 24 mL of water and another 16 mL of 15 wt % NaOH aqueous solution in a beaker. The mixture was stirred at 500 rpm at room temperature for 2 h. Then, 1.2 g of chloroacetic acid was added to the reaction mixture and stirred for 30 min. The mixture was then heated to 55° C. and stirred for another 3 h. After the reaction, the product CM-Ok(01)-b2 was collected by centrifugation and lyophilized.

The carboxymethylation was through alkalization and etherification of the hydroxyl groups with chloroacetic acid in the presence of alkali. From route (a) to (b1), the use of organic solvent was reduced, and then fully eliminated in route (b2).

Fourier transform infrared (FTIR) spectra of polymers in KBr were recorded on a Perkin-Elmer FTIR 2000 spectrometer in the region of 4000-500 cm⁻¹.

Characterization

The FT-IR spectra of Ok(01)-I and CM-Ok(01)-I-a synthesized using 15 wt % and 25 wt %

NaOH via route (a) were shown in FIG. 13. The band around 1600 cm⁻¹ is due to C═O stretching. The bands around 1420 cm⁻¹ and 1000-1200 cm⁻¹ are due to —CH₂ scissoring and —O— stretching, respectively (see Rachtanapun, P et. al. Journal of Applied Polymer Science 2011, 122 (5), 3218-3226 and Rachtanapun, P., Blended films of carboxymethyl cellulose from papaya peel (CMCp) and corn starch. 2009; Vol. 43, p 259-266). Both CM-Ok(01)-I-a synthesized showed stronger absorption bands for the carbonyl group (C═O), —CH₂ group and ether group (—O—) than Ok(01)-I. These results indicated the successful carboxymethylation of the polymers.

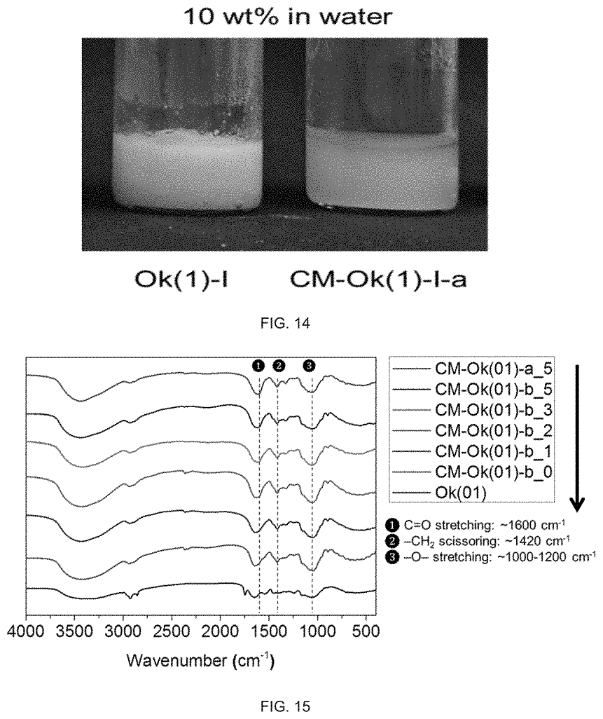

The solubility of the CM-Ok(01)-I-a in water was also improved as compared to raw Ok(01)-I. FIG. 14 shows the two polymers in water (10 wt %). This improvement in solubility also proves the successful modification of Ok(01)-I with carboxymethyl groups.

Carboxymethylation of Ok(01) via both route (a) and (b) was performed and analyzed by FT-IR. The reaction parameters were shown in Table 6. The products for FT-IR characterization were all purified by precipitation in methanol, neutralized with acetic acid, washed with methanol and then dried under vacuum. From the FT-IR spectra in FIG. 15 it was observed that CM-Ok(01)-a and CM-Ok(01)-b synthesized using higher amount of chloroacetic acid showed stronger absorption bands for the carbonyl group (C═0), —CH₂ group and ether group (—O—) than Ok(01). These results indicated the successful carboxymethylation of the polymers.

TABLE 6
Reaction parameters for carboxymethylation of Ok(01) via route (a) and (b).

| | Weight of Reactants (mg) | | Weight Ratio of | Volume of Solvent (mL) | | |
|---|---|---|---|---|---|---|
| | | Chloroacetic | Ok(01):Chloroacetic | 15 wt % | DI | |
| Product Code | Ok(01) | Acid | Acid | NaOH | Water | IPA |
| CM-Ok(01)-b_0 | 500 | 0 | 1:0 | 4 | 6 | 0 |
| CM-Ok(01)-b_1 | 500 | 100 | 1:0.2 | 4 | 6 | 0 |
| CM-Ok(01)-b_2 | 500 | 200 | 1:0.4 | 4 | 6 | 0 |
| CM-Ok(01)-b_3 | 500 | 300 | 1:0.6 | 4 | 6 | 0 |
| CM-Ok(01)-b_5 | 500 | 500 | 1:1 | 4 | 6 | 0 |
| CM-Ok(01)-a_5 | 500 | 500 | 1:1 | 4 | 6 | 24 |

### Example 8

### Crosslinking of Carboxymethylated Okara-Based Gel Enhances Water Absorbancy, Gel Properties

Carboxymethylated okara-based polymers were crosslinked with various amounts of epoxy crosslinkers, e.g. polyethylene glycol diglycidyl ether (PEGDE), in the presence of aqueous alkali to produce a series of crosslinked carboxymethylated okara-based gels. The protocol was adapted from the reported procedure for crosslinking CMC into hydrogels (see Kono, H., Carbohydrate Polymers 2014, 106, 84-93). The synthetic scheme and typical workflow was shown in FIGS. 16A and 16B.

Typically, 100 mg of CM-Ok(01)-a, which was synthesized using 15 wt % NaOH, was dispersed in 0.5 mL of 1.5 M aqueous NaOH solution. 120 mg of PEGDE was then added to the suspension while stirring at room temperature. The crosslinking reaction was conducted at 60° C. for 3 h to obtain the hydrogel. Ok(01) was also crosslinked with PEGDE following the same protocol in a control experiment.

Route (a)

A series of CM-Ok(01)-a-PEG hydrogels were prepared by crosslinking CM-Ok(01)-a, which was synthesized using 15 wt % NaOH and a weight ratio of Ok(01):chloroacetic acid of 1:1.

Various amounts of PEGDE crosslinker were used. The feed ratios of polymers to crosslinkers were summarized in Table 7. During the crosslinking reaction, the CM-Ok(01)-a suspension gradually became more viscous and eventually formed a gel. It was observed that if the amount of PEGDE crosslinker decreased to 40 mg, the reaction mixture could not form a gel and remained as a suspension. In addition, Ok(01) was also crosslinked with 120 mg of PEGDE in a control experiment, but it did not form a gel. The appearance of the reaction products of Table 7 was shown in FIGS. 17A to 17E. This further proves the successful carboxymethylation of Ok(01) in the synthesis step, which subsequently helped in gel formation.

TABLE 7
Reaction parameters for crosslinking Ok(01) and CM-Ok(01)-a with
PEGDE crosslinker for the synthesis of CM-Ok(01)-a-PEG hydrogels.

| | Starting Compound^{b} | | | PEGDE | | | 1.5M | |
|---|---|---|---|---|---|---|---|---|
| Product | | Weight | Conc. | Weight | Conc. | Weight Ratio of | NaOH | Product |
| Code^{a} | Name | (mg) | (wt %) | (mg) | (wt %) | Polymer:PEGDE | (mL) | Appearance |
| Ok(01)-PEG | Ok(01) | 100 | 13.9 | 120 | 16.7 | 1:1.2 | 0.50 | Suspension |
| (1:1.2) | | | | | | | | |
| CM-Ok(01)-a-PEG | CM-Ok(01)-a | 100 | 13.9 | 120 | 16.7 | 1:1.2 | 0.50 | Gel |
| (1:1.2) | | | | | | | | |
| CM-Ok(01)-a-PEG | CM-Ok(01)-a | 100 | 13.9 | 80 | 11.1 | 1:0.8 | 0.54 | Gel |
| (1:0.8) | | | | | | | | |
| CM-Ok(01)-a-PEG | CM-Ok(01)-a | 100 | 13.9 | 60 | 8.3 | 1:0.6 | 0.56 | Gel |
| (1:0.6) | | | | | | | | |
| CM-Ok(01)-a-PEG | CM-Ok(01)-a | 100 | 13.9 | 40 | 5.6 | 1:0.4 | 0.58 | Suspension |
| (1:0.4) | | | | | | | | |

^{a}The ratio in the bracket is the weight ratio of polymer:PEGDE.
^{b}Ok(01) was used as a control. CM-Ok(01)-a was synthesized using 15 wt % NaOH and a weight ratio of Ok(01):chloroacetic acid = 1:1.

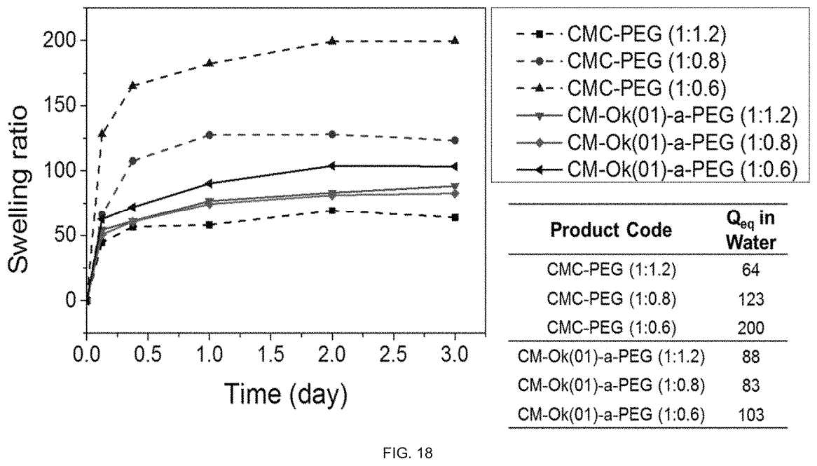

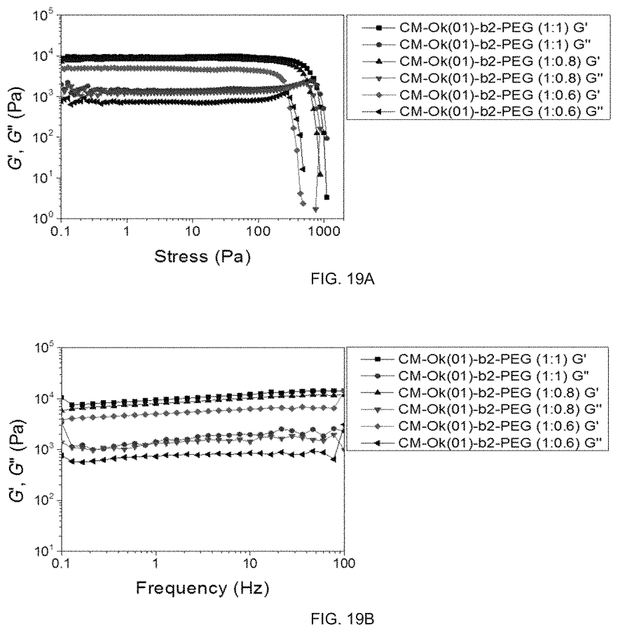

The equilibrium swelling ratios of CM-Ok(01)-a-PEG hydrogels in water were shown in FIG. 18. The CMC-PEG hydrogels were synthesized using the same parameters as CM-Ok(01)-a-PEG hydrogels and used as controls. The results showed that the hydrogels formed by crosslinking CM-Ok(01)-a had a reasonably high water absorbency in water.

Route (b1)

A series of CM-Ok(01)-b1-PEG hydrogels were prepared by crosslinking CM-Ok(01)-b1, which was synthesized using 15 wt % NaOH and different amounts of chloroacetic acid. In addition, various amounts of PEGDE crosslinker were used. The feed ratios of polymers to crosslinkers were summarized in Table 8. It was observed that all formulations formed gels, except CM-Ok(01)-b1_0-PEG (1:0.6) which remained as a suspension. As no chloroacetic acid was used for the synthesis of CM-Ok(01)-b1_0, this further proves the successful carboxymethylation of Ok(01) in the synthesis step for CM-Ok(01)-b1_3 and CM-Ok(01)-b1_5, which subsequently helped in gel formation.

TABLE 8
Reaction parameters for crosslinking CM-Ok(01)-b1 with PEGDE
crosslinker for the synthesis of CM-Ok(01)-b1-PEG hydrogels.

| | Starting Compound^{b} | | | PEGDE | | | Volume | |
|---|---|---|---|---|---|---|---|---|
| Product | | Weight | Conc. | Weight | Conc. | Weight Ratio of | of Water | Product |
| Code^{a} | Name | (mg) | (wt %) | (mg) | (wt %) | Polymer:PEGDE | (mL) | Appearance |
| CM-Ok(01)-b1_0-PEG | CM-Ok(01)-b1_0 | 500 | 12.5 | 500 | 12.5 | 1:1 | 3 | Gel |
| (1:1) | | | | | | | | |
| CM-Ok(01)-b1_3-PEG | CM-Ok(01)-b1_3 | 500 | 12.5 | 500 | 12.5 | 1:1 | 3 | Gel |
| (1:1) | | | | | | | | |
| CM-Ok(01)-b1_5-PEG | CM-Ok(01)-b1_5 | 500 | 12.5 | 500 | 12.5 | 1:1 | 3 | Gel |
| (1:1) | | | | | | | | |
| CM-Ok(01)-b1_0-PEG | CM-Ok(01)-b1_0 | 500 | 12.5 | 400 | 10.0 | 1:0.8 | 3.1 | Gel |
| (1:0.8) | | | | | | | | |
| CM-Ok(01)-b1_3-PEG | CM-Ok(01)-b1_3 | 500 | 12.5 | 400 | 10.0 | 1:0.8 | 3.1 | Gel |
| (1:0.8) | | | | | | | | |
| CM-Ok(01)-b1_5-PEG | CM-Ok(01)-b1_5 | 500 | 12.5 | 400 | 10.0 | 1:0.8 | 3.1 | Gel |
| (1:0.8) | | | | | | | | |
| CM-Ok(01)-b1_0-PEG | CM-Ok(01)-b1_0 | 500 | 12.5 | 300 | 7.5 | 1:0.6 | 3.2 | Suspension |
| (1:0.6) | | | | | | | | |
| CM-Ok(01)-b1_3-PEG | CM-Ok(01)-b1_3 | 500 | 12.5 | 300 | 7.5 | 1:0.6 | 3.2 | Gel |
| (1:0.6) | | | | | | | | |
| CM-Ok(01)-b1_5-PEG | CM-Ok(01)-b1_5 | 500 | 12.5 | 300 | 7.5 | 1:0.6 | 3.2 | Gel |
| (1:0.6) | | | | | | | | |

^{a}The ratio in the bracket is the weight ratio of polymer:PEGDE.
^{b}CM-Ok(01)-b1 were synthesized using different amounts of chloroacetic acid as listed in Table 6.

The equilibrium swelling ratios of CM-Ok(01)-b1-PEG hydrogels in both water and saline were shown in Table 9. Generally, the water absorbency capacity of CM-Ok(01)-b1-PEG hydrogels was lower than that of CM-Ok(01)-a-PEG hydrogels. However, less organic solvent was used for the synthesis of CM-Ok(01)-b1. In addition, the equilibrium swelling ratios of CM-Ok(01)-b1-PEG hydrogels did not differ much in water and saline.

TABLE 9
Equilibrium swelling ratios of
CM-Ok(01)-b1-PEG hydrogels in water and saline.

| Hydrogel^{a} | Q_{eq} in tap water | Q_{eq} in 0.9% NaCl |
|---|---|---|
| CM-Ok(01)-b1_0-PEG (1:1) | 26.0 | 25.6 |
| CM-Ok(01)-b1_3-PEG (1:1) | 30.0 | 25.4 |
| CM-Ok(01)-b1_5-PEG (1:1) | 34.6 | 32.2 |
| CM-Ok(01)-b1_0-PEG (1:0.8) | 14.1 | 11.4 |
| CM-Ok(01)-b1_3-PEG (1:0.8) | 27.1 | 20.7 |
| CM-Ok(01)-b1_5-PEG (1:0.8) | 30.2 | 27.3 |
| CM-Ok(01)-b1_3-PEG (1:0.6) | 44.2 | 35.1 |
| CM-Ok(01)-b1_5-PEG (1:0.6) | 26.4 | 27.3 |

^{a}CM-Ok(01)-b1-PEG hydrogels were synthesized using the parameters listed in Table 8.

Route (b2)

A series of CM-Ok(01)-b2-PEG hydrogels were prepared by crosslinking CM-Ok(01)-b2, which was synthesized using 15 wt % NaOH and a weight ratio of Ok(01):chloroacetic acid of 1:0.6. Various amounts of PEGDE crosslinker were used. The feed ratios of polymers to crosslinkers were summarized in Table 10. It was observed that all formulations formed gels, except Ok(01)-PEG (1:1) which was synthesized and used as a control. This further proves the successful carboxymethylation of Ok(01) in the synthesis step, which subsequently helped in gel formation.

TABLE 10
Reaction parameters for crosslinking Ok(01) and CM-Ok(01)-b2 with
PEGDE crosslinker for the synthesis of CM-Ok(01)-b2-PEG hydrogels.

| | Starting Compound^{b} | | | PEGDE | | | Volume | |
|---|---|---|---|---|---|---|---|---|
| Product | | Weight | Conc. | Weight | Conc. | Weight Ratio of | of Water | Product |
| Code^{a} | Name | (mg) | (wt %) | (mg) | (wt %) | Polymer:PEGDE | (mL) | Appearance |
| Ok(01)-PEG | Ok(01) | 500 | 28.6 | 500 | 28.6 | 1:1 | 0.75 | Suspension |
| (1:1) | | | | | | | | |
| CM-Ok(01)-b2-PEG | CM-Ok(01)-b2 | 500 | 28.6 | 500 | 28.6 | 1:1 | 0.75 | Gel |
| (1:1) | | | | | | | | |
| CM-Ok(01)-b2-PEG | CM-Ok(01)-b2 | 500 | 28.6 | 400 | 22.9 | 1:0.8 | 0.85 | Gel |
| (1:0.8) | | | | | | | | |
| CM-Ok(01)-b2-PEG | CM-Ok(01)-b2 | 500 | 28.6 | 300 | 17.1 | 1:0.6 | 0.95 | Gel |
| (1:0.6) | | | | | | | | |

^{a}The ratio in the bracket is the weight ratio of polymer:PEGDE.
^{b}Ok(01) was used as a control. CM-Ok(01)-b2 was synthesized using 15 wt % NaOH and a weight ratio of Ok(01):chloroacetic acid = 1:0.6.

The equilibrium swelling ratios of CM-Ok(01)-b2-PEG hydrogels in both water and saline were shown in Table 11. Generally, the water absorbency capacity of CM-Ok(01)-b2-PEG hydrogels was lower than that of CM-Ok(01)-a-PEG and CM-Ok(01)-b1-PEG hydrogels, but higher than that of Ok(01) and Ok(01)-PEG (1:1). A point to note was the hydrogels synthesized in this route did not use any organic solvent. The equilibrium swelling ratios of CM-Ok(01)-b2-PEG hydrogels as obtained through this route did not differ much in water and saline.

TABLE 11
Equilibrium swelling ratios of Ok(01), Ok(01)-PEG (1:1) and
CM-Ok(01)-b2-PEG hydrogels in water and saline.

| Sample^{a} | Q_{eq} in tap water | Q_{eq} in 0.9% NaCl |
|---|---|---|
| Ok(01) | 9.3 | 8.2 |
| Ok(01)-PEG (1:1) | 9.5 | 7.5 |
| CM-Ok(01)-b2_3-PEG (1:1) | 21.6 | 18.7 |
| CM-Ok(01)-b2_3-PEG (1:0.8) | 25.3 | 22.0 |
| CM-Ok(01)-b2_3-PEG (1:0.6) | 29.6 | 24.1 |

^{a}Ok(01)-PEG (1:1) and CM-Ok(01)-b2-PEG hydrogels were synthesized using the parameters listed in Table 10.

Oscillatory time sweeps were performed at a constant shear stress of 1.0 Pa and a fixed frequency of 1.0 Hz at 25° C. Oscillatory stress sweeps were performed by applying increasing shear stress logarithmically from 0.1 Pa at a constant frequency of 1.0 Hz at 25° C., until the hydrogels were destroyed, as evidenced by a G′/G″ crossover, and 100% deformation was reached. Oscillatory frequency sweeps were performed from 0.1 to 100 Hz at a constant shear stress of 1.0 Pa at 25° C.

In FIGS. 19A and 19B, the oscillatory stress sweep measurement and oscillatory frequency sweep measurement of CM-Ok(01)-b2-PEG hydrogels showed that these hydrogels are relatively stiff and strong, as evidenced by the high G′ and yield point, respectively. Therefore, this type of hydrogels may be more suitable for applications whereby high stiffness and strength of the hydrogels are required.

### Example 9

### Nutrigel Testing on the Growth of a Model Vegetable, Brassica rapa L. var. parachinensis (Commonly Known as Choy sum)

Screening of nutrigels for plant growth performance.

Three nutrigels that had been prepared as mentioned in Table 3, Example 3 were selected for growth performance studies. Gel1, Gel2 and Gel3 (Table 12) were evaluated for their effect on the growth of a commonly-consumed Asian vegetable, Choy sum (Brassica rapa L. var. parachinensis). The nutrigels were mixed with commercially-available potting mix (Jiffy Substrates; Toul, France) at 1 or 3% (w/w) before they were transferred into the 50-cavity-germination tray. Controls (without nutrigel) were also prepared in the same germination tray before water was added through sub-irrigation. Seeds were sowed (DO) and all plants were grown in an indoor laboratory facility, equipped with LED lights (˜160 μmol m⁻² 5⁻¹; 12 h/12 h light/dark). A total of 7 plants were grown for each treatment till 16 days after sowing (D16) before they were harvested for growth assessment. The growth stages (i.e., number of true leaves at harvest) of the plants and their fresh weights (FW) were recorded. In addition, total leaf area of each plant was determined by first taking the images of leaf laminae for each plant using a camera (Canon EOS 550D; Tokyo, Japan) followed by area determination using Image J v. 1.51 (National Institute of Health; Bethesda, Md., USA).

TABLE 12
Selected nutrigels for growth studies.

| Sample ID | Gel Code | % (w/w) added |
|---|---|---|
| Gel1 | Gel1-2 A7M3B0.05 | 1 or 3 |
| Gel2 | Gel1-2 A5M5B0.05 | 1 or 3 |
| Gel3 | Gel1-2 A3M7B0.05 | 1 or 3 |

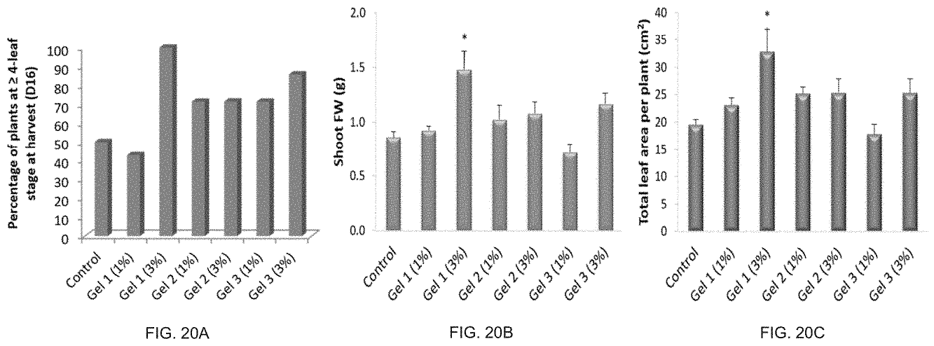

Among the nutrigels tested, Gel1 showed the best performance on the growth of the vegetable (FIGS. 20A to 20C). All the plants grown in potting mix supplemented with 3% Gel1 were at the 4-leaf stage (FIG. 20A). Highest shoot FW (FIG. 20B) and largest leaf area (FIG. 20C) were determined for these plants and results were significant as compared to the controls (i.e., plants grown without nutrigel). Gel1 was used in subsequent performance studies.

Effect of Gel1 on seed germination and initial growth of vegetable.

To determine if the concentration of Gel1 will affect germination efficiency and initial growth of the vegetable, seeds were sowed in petri dishes containing 0-5% (w/w) Gel1. A total of 20 seeds were sowed in each petri dish and 6 petri dishes of such were prepared for each treatment (i.e., total of 120 seeds scored). The percentage of seeds germinated for each treatment was recorded on the first and second days after sowing. Seedlings with fully expanded cotyledons were scored on the third day after sowing.

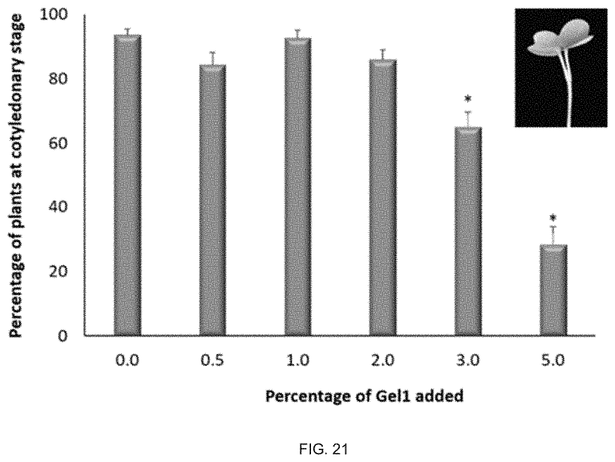

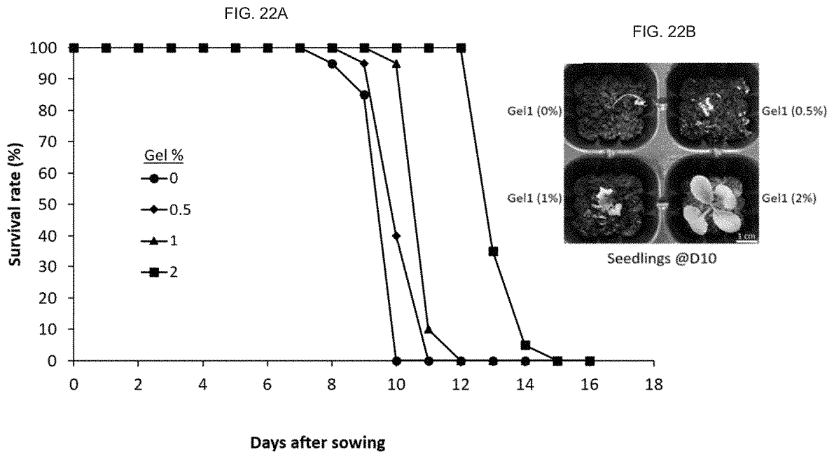

From the study, almost all seeds (>95%) germinated one day after sowing when the seeds were incubated in potting mix supplemented with 0-3% Gel1 (Table 13). The germination of the seeds was thus not significantly inhibited if up to 3% of Gel1 was used. Initial growth of the seedlings up till the cotyledonary stage was also not significantly arrested if up to 2% of Gel1 was used (FIG. 21).

TABLE 13
Effect of various concentrations of Gel1 on seed germination.

| Gel1 % (w/w) | % Germination on Day 1 | % Germination on Day 2 |
|---|---|---|
| 0.0 | 100.00 ± 0.00^{a} | 100.00 ± 0.00^{a} |
| 0.5 | 96.67 ± 1.67^{a} | 100.00 ± 0.00^{a} |
| 1.0 | 98.33 ± 1.05^{a} | 100.00 ± 0.00^{a} |
| 2.0 | 97.50 ± 1.12^{a} | 99.17 ± 0.83^{a} |
| 3.0 | 97.50 ± 1.12^{a} | 98.33 ± 1.05^{ac} |
| 5.0 | 88.33 ± 1.05^{b} | 94.17 ± 2.01^{bc} |

Different letters next to numbers within the same column indicate significance (One-way ANOVA, Tukey's post-hoc test, p<0.05).

Seedlings survive better under drought-stress conditions in the presence of 2% Gel1.

A study was conduct to determine how well the vegetable seedlings could cope with drought-stress condition in the presence of Gel1. In this study, seeds (n=20) were sowed directly in potting mix supplemented with 0-2% Gel1. A one-time addition of water right at the beginning (to fully-saturate the potting mix with water) prior to seed sowing was performed. No further addition of water was conducted and the survival capability of the seedlings were recorded on a daily basis till all plants died. The results showed that seeds sowed in water-saturated potting mix supplemented with 2% Gel1 performed much better, with 100% of the seedlings survived up till 12 days after sowing without further addition of water, in contrast to none of the seedlings survived beyond 9 days after sowing (FIGS. 22A and 22B). Seedlings grown in potting mix supplemented with 2% Gel1 are thus able to tolerate drought condition better than those without nutrigel addition.

Gel1 at 2% promotes growth by 80% under water-limited conditions.

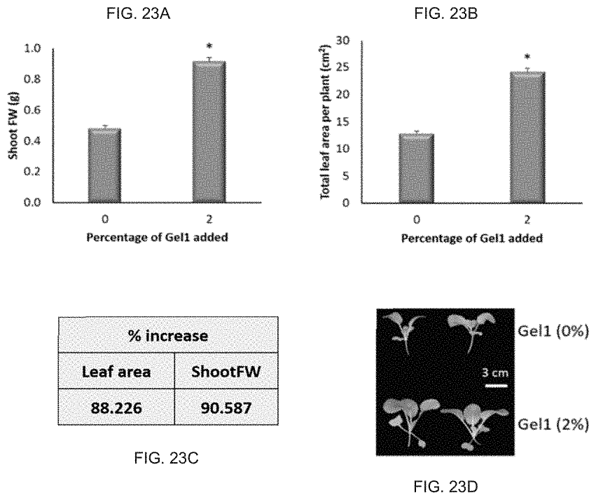

For growth assessment, the seedlings were grown under water-limited conditions rather than under extreme drought stress condition, as in the preceding section. As before, seedlings (n=20) were sowed directly in potting mix supplemented with 2% Gel1 or without any addition of the nutrigel. The plants were only watered thrice till harvesting at D16 (i.e., 16 days after sowing). Under this condition, the growth of seedlings germinated and grown directly in potting mix with 2% Gel1 was almost doubled (-88-90% increase) as compared to those grown without Gel1 (FIGS. 23A to 23D).

Conclusion

Various strategies were developed for converting okara into super water-absorbent “Nutrigel” for controlled release of nutrients and efficient water retention. In one example, the okara-based Nutrigels were synthesized through graft copolymerization of okara with monomers. In another example, the okara-based Nutrigels were synthesized through directly grafting carboxymethyl groups to okara followed by crosslinking. The properties of the Nutrigels are being optimised toward application as soil supplements, including water absorbency and water-holding capacity, release kinetics of the encapsulated nutrients in water and in soil. Subsequently, the effects of Nutrigels on vegetable growth were determined and their feasibility to be utilized as soil supplements was analyzed.

1. A superabsorbent hydrogel comprising a crosslinked polymeric network comprising polymeric chains grafted onto particles of okara, wherein the crosslinks are formed through:
the polymeric chains; and/or
each okara particle being bonded to one or more polymeric chains.

2. The hydrogel according to claim 1, wherein the okara particles are one or more of unfractionated okara particles, water-insoluble okara particles, and water-soluble okara particles.

3. The hydrogel according to claim 1, wherein the hydrogel further comprises a plant nutrient material.

4. The hydrogel according to claim 3, wherein the plant nutrient material is urea.

5. The hydrogel according to claim 1, wherein the polymeric chains are formed from poly(acrylic acid), poly(acrylamide) or copolymers thereof.

6. The hydrogel according to claim 5, wherein the crosslinks formed through the polymeric chains are derived from a bisacrylamide crosslinking agent.

7. The hydrogel according to claim 5, wherein the crosslinking agent is present in the hydrogel in an amount of from 0.010 to 2 dry wt % of the hydrogel.

8. The hydrogel according to claim 5, wherein the okara particles form from 15 to 50 dry wt % and the polymeric chain forms from 50 to 85 dry wt % of the hydrogel.

9. The hydrogel according to claim 5, wherein the polymeric chains are a copolymer of acrylic acid and acrylamide.

10. The hydrogel according to claim 9, wherein the weight to weight ratio of acrylic acid to acrylamide in the polymeric chains is from 1:10 to 10:1.

11. The hydrogel according to claim 5, wherein the hydrogel has an equilibrium swelling value of from 90 to 500 at a pH value of around 7.

12. The hydrogel according to claim 1, wherein the hydrogel is formed by the reaction of carboxylated okara particles that comprise one or more carboxylic acid functional groups with polymeric chains that comprise two or more epoxide groups, where an ester linkage is formed by reaction of a carboxylate group with an epoxide.

13. The hydrogel according to claim 12, wherein the polymeric chains that comprise two or more epoxide linkages are polyethylene glycol diglycidyl ether.

14. The hydrogel according to claim 12, wherein the weight to weight ratio of carboxylated okara to polymeric chains that comprise two or more epoxide groups is from 1:2 to 2:1.

15. The hydrogel according to claim 12, wherein the hydrogel has an equilibrium swelling value of from 10 to 110.

16. (canceled)

17. (canceled)

18. A composite material suitable for use in growing plants, comprising a soil and a superabsorbent hydrogel as defined in claim 1.

19. The composite material according to claim 18, wherein the composite material comprises from 0.5 to 10 dry wt % of the hydrogel.

20. (canceled)

21. The composite material according to claim 19, wherein the composite material has a water holding percentage of from 125 to 250%.

22. (canceled)

23. (canceled)

24. A method of forming a superabsorbent hydrogel as defined in claim 5, the method comprising the steps of:
(a) providing an aqueous suspension of okara;
(b) adding a radical initiator to the aqueous suspension to form a first reaction mixture that was aged for a first period of time; and
(c) adding acrylic acid and/or acrylamide with a crosslinking agent to the first reaction mixture to form a second reaction mixture that was aged for a second period of time to form the superabsorbent hydrogel.

25. A method of forming a superabsorbent hydrogel as defined in claim 12, the method comprising the steps of:
(a) providing an aqueous suspension of carboxylated okara in an alkaline aqueous solution; and
(b) adding a polymeric chain material that has two or more epoxide groups to the aqueous suspension to react with the carboxylated okara to form the superabsorbent hydrogel.
